(19) United States
(12) Patent Application Publication
(10) Pub. No.: US 2026/0270760 A1
(43) Pub. Date: Sep. 10, 2026

(54) OPERATING CONDITIONS FOR TRIGGERED BASED UPLINK TRANSMISSIONS IN EMLSR OR EMLMR CO-AFFILIATED STATIONS

(71) Applicant: CANON KABUSHIKI KAISHA, Tokyo (JP)

(72) Inventors: Mickaël LORGEOUX, RENNES (FR); Julien SEVIN, SAINT AUBIN DU CORMIER (FR); Pascal VIGER, JANZE (FR)

(21) Appl. No.: 18/880,186

(22) PCT Filed: Jun. 30, 2023
(86) PCT No.: PCT/EP2023/068012

§ 371 Date: Dec. 30, 2024

(30) Foreign Application Priority Data
Jul. 1, 2022 (GB) 2209733.1

(51) Int. Cl. H04W 28/02; H04W 72/1268

(52) U.S. Cl. CPC H04W 28/0263; H04W 28/0278; H04W 72/1268

(57) ABSTRACT

A non-AP MLD operates on multi-links with an UL TID-To-Link mapping. When activating the EML mode, it selects a set of EML links in which links the EML mode is applied, as a function of the UL TID-To-Link mapping, and it transmits to an AP MLD a notification specifying the selected set of EML links. In addition or as an alternative, while the non-AP MLD operates in an EML mode with a set of EML links, it transmits, in response to a BSRP TF received from the AP MLD over a first EML link of the set of EML links, a BSR frame reporting buffered traffic as a function of the UL TID-To-Link mapping, to the AP MLD, over the first EML link.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE®) provides a great number of mechanisms for wireless communications between STAs.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D2.0 version (May 2022, below “D2.0 standard”) introduces the Multi-Link (ML) Operation (MLO). MLO improves data throughput by allowing communications between STAs over multiple concurrent and non-contiguous communication links.

MLO enables a non-AP (Access Point) MLD (ML Device) to register with an AP MLD, i.e. to discover, authenticate, associate and set up multiple links with the AP MLD. Each link enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

With the introduction of MLO and of spatial multiplexing capabilities of the MLDs, new Operating Modes (OM) referred to as Enhanced Multi-Link Operating Mode (EML OM), have been introduced in the D2.0 standard, namely the EMLSR (Enhanced Multi-Link Single Radio) mode and the EMLMR (Enhanced Multi-Link Multi-Radio) mode.

The non-AP MLDs declare their support of the EML Operating Modes (known as EML Capabilities) to the AP MLD during the association phase. In operation mode, the activation and the deactivation of an EML Operation Mode is initiated by the non-AP MLD which sends a specific EHT action frame referred to as “EML OM Notification”. The D2.0 standard states that the two EMLSR and EMLMR modes are mutually exclusive.

The EMLMR mode, once activated, allows the non-AP MLD to simultaneously listen to a set of enabled links (so-called EMLMR links, usually made of two enabled links) to receive an initial frame transmitted by the AP MLD to initiate frame exchange and next to aggregate some physical resources of its different radios used on different links (so-called EMLMR links) in order to transmit or receive data up to a pre-defined number of supported Rx/Tx spatial streams, over only one EMLMR link at a time, usually the link over which the initial frame is received. The number may be greater than the number of supported Rx/Tx spatial streams of each radio. The frame exchange sequence initiated by the AP MLD may be either a Triggered Based (TB) Downlink (DL) transmission or a Triggered Based (TB) Uplink (UL) transmission on the link in which the initial frame was received.

The EMLSR mode, once activated, allows a non-AP MLD to simultaneously listen to a set of enabled links (so-called EMLSR links, usually made of two enabled links) to receive an initial control frame (e.g. an MU-RTS trigger frame, a BSRP trigger frame) from the AP MLD to initiate frame exchange and next to perform data frames exchange with the AP MLD over only one EMLSR link at a time, usually the link over which the initial control frame is received. The frame exchange sequence initiated by the AP MLD may be either a Triggered Based (TB) Downlink (DL) transmission or a Triggered Based (TB) Uplink (UL) transmission on the link in which the initial control frame was received.

With the introduction of MLO, the D2.0 standard defines also the Traffic IDentifier(TID)-To-Link mapping mechanism. This mechanism allows an AP MLD and a non-AP MLD that performed or are performing multi-link setup to determine how UL and DL QoS traffic corresponding to TID values between 0 and 7 are assigned to the setup links for the non-AP MLD. By default, all TIDs are mapped onto all setup links for both DL and UL, and all setup links are enabled. The D2.0 standard defines a procedure allowing a TID-To-Link mapping negotiation in DL and/or UL directions between an initiating MLD and a responding MLD.

In the EMLMR or EMLSR frame exchange operations initiated by the AP MLD as currently specified in IEEE P802.11be/D2.0, the choice of the EMLMR or EMLSR link used for the frame exchange sequence is driven by the AP MLD when sending the Initial frame or Initial Control frame. Currently, the standard doesn't specify any rule for the matching of this chosen EMLMR link or EMLSR link with the TID-To-Link mapping in use between the AP MLD and non-AP MLD. In some situations, especially for TB UL traffic, this lack of rules may lead to some mismatches and inefficiencies. For example, a TB UL transmission opportunity may be provided by the AP MLD to the non-AP MLD on an EMLMR or EMLSR link on which there is no TID mapped or not the TIDs currently buffered by the non-AP MLD. It results that the TB UL transmission opportunity is lost, while the non-AP MLD being in a frame exchange state over the concerned EMLMR or EMLSR link also loses any opportunity to transmit over the other EMLMR or EMLSR link(s).

### SUMMARY OF INVENTION

It is a broad objective of the present invention to harmonize EML modes operations, be it EMLMR or EMLSR, with the Uplink TID-To-Link mapping for Trigger Based, TB, Uplink traffic, UL, transmission.

In this context, embodiments of the invention provide a communication method in a wireless network, comprising, at a non-access point, non-AP, multi-link device, MLD operating on multi-links with an Uplink, UL, Traffic IDentifier(TID)-To-Link mapping, at least one of:
activating an Enhanced Multi-Link, EML, mode, wherein activating the EML mode includes selecting a set of EML links in which links the EML mode is applied, as a function of the UL TID-To-Link mapping, and transmitting to an AP MLD a notification specifying the selected set of EML links; and
while the non-AP MLD operates in an EML mode with a set of EML links, transmitting, in response to a Buffer Status Report Poll, BSRP, trigger frame received from the AP MLD over a first EML link of the set of EML links, a BSR frame reporting buffered traffic as a function of the UL TID-To-Link mapping, to the AP MLD, over the first EML link.

By taking into account the TID-to-Link mapping in the setup of the EML links for the EML mode and/or in the BSR, the invention can ensure the EML link used by the AP MLD to trigger the frame exchange is appropriate for TB UL communication for the non-AP MLD. This allows to avoid or reduce the aforesaid mismatches and inefficiencies between EML modes operations and UL TID-To-Link mapping for TB UL traffic transmission.

More generally, taking into account the TID-to-Link mapping in the setup of the links may also apply in a multi-link mode, regardless of any EML mode. Thus, more general embodiments of the invention provide a communication method in a wireless network, comprising, at a non-AP MLD operating on multi-links with an UL TID-To-Link mapping: while the non-AP MLD operates in a multi-link mode with a set of links, transmitting, in response to a BSRP trigger frame received from an AP MLD over a first link of the set of links, a BSR frame reporting buffered traffic as a function of the UL TID-To-Link mapping, to the AP MLD, over the first link. In some embodiments according to this more general approach, the BSR frame reports buffered traffic, if any, of at least one UL TID that is mapped on the first link according to the UL TID-To-Link mapping. In some other embodiments, the BSR frame reports buffered traffic, if any, only of UL TID(s) that is (are) mapped on the first link according to the UL TID-To-Link mapping.

Optional features of the embodiments of the invention are defined below with reference to methods, while they can be transposed into device features.

In some embodiments, selecting the set of EML links as a function of the UL TID-To-Link mapping comprises fulfilling a constraint that at least one EML link of the set of EML links shall have at least one UL TID mapped according to the UL TID-To-Link mapping.

This feature avoids to have a set of EML links on which no UL TID is mapped according to the UL TID-To-Link mapping and where the AP MLD is liable to trigger the non-AP MLD for an UL transmission on a link of this set of EML links. Loss of such a TB UL transmission is therefore avoided. This feature (and its constraint) preferentially applies if the UL TID-To-Link mapping is a negotiated UL TID-To-Link mapping with a TID-To-Link Mapping Negotiation Supported subfield value equal to 1.

In some embodiments, selecting the set of EML links as a function of the UL TID-To-Link mapping comprises fulfilling a constraint that the set of EML links shall not be disjoint from another set of links on each of which all UL TIDs are mapped according to the UL TID-To-Link mapping.

In other words, for these embodiments, at least one of the EML links of the set of EML links shall be included in another set of links on each of which all UL TIDs are mapped according to the UL TID-To-Link mapping. This feature also allows to avoid the case where a set of EML links has no UL TID mapped on it according to the UL TID-To-Link mapping and where the AP MLD is liable to trigger the non-AP MLD for an UL transmission on a link of this set of EML links. This feature (and its constraint) preferentially applies if the UL TID-To-Link mapping is a negotiated UL TID-To-Link mapping with a TID-To-Link Mapping Negotiation Supported subfield value equal to 2.

In some embodiments, the BSR frame reports buffered traffic, if any, of at least one UL TID that is mapped on the first EML link according to the UL TID-To-Link mapping.

This feature also allows to avoid the case where the BSR response frame sent by the non-AP MLD report buffered traffic for TIDs all not mapped on the first link over which the BSRP TF was received. Indeed, in such a case, the triggering of the non-AP MLD for an UL transmission by the AP MLD on the first link is useless and the overall EML operation initiated is inefficient.

In some embodiments, the BSR frame reports buffered traffic, if any, only of UL TID(s) that is (are) mapped on the first EML link according to the UL TID-To-Link mapping.

This feature guarantees that the non-AP MLD can take benefit of any TB UL transmission that is scheduled by the AP MLD on the first link based on the BSR.

This feature and the previous one (and their respective constraint) preferentially apply if the UL TID-To-Link mapping is a negotiated UL TID-To-Link mapping with a TID-To-Link Mapping Negotiation Supported subfield value equal to 1.

In some embodiments, the BSRP trigger frame is an initial frame triggering a frame exchange sequence over the first EML link, and the method, at the non-AP station, further comprises:
obtaining a scheduled UL resource within the frame exchange sequence; and
transmitting, within the scheduled UL resource, data having an UL TID that is mapped on the first EML link according to the UL TID-To-Link mapping as reported in the BSR frame.

Thus the non-AP MLD can transmit data without mismatches between EML modes operations and Uplink TID-To-Link mapping for TB UL traffic transmission.

The initial frame triggering a frame exchange sequence is called “initial frame” in the EMLMR mode and “initial control frame” in the EMLSR mode.

In some embodiments, the method further comprises, at the non-AP MLD, transmitting to the AP MLD a signaling information indicating which of the two following submodes of the EML mode is to be used:
a first submode of the EML mode including said transmission of the BSR frame reporting buffered traffic as a function of the UL TID-To-Link mapping; and
a second submode of the EML mode, in which, in response to a BSRP trigger frame received from the AP MLD over the first EML link, the non-AP MLD transmits to the AP MLD, over the first EML link, a BSR frame indicating a selected EML link among the set of EML links which is to be used for a frame exchange.

Thus, the non-AP MLD explicitly signal which of two submodes of the EML mode it uses. Below, the first and second submodes of the EML mode are also referred to as “current EML operation for TB UL traffic” and “new EML operation for TB UL traffic” respectively.

Embodiments of the invention also provide a communication method in a wireless network, comprising, at a non-access point, non-AP, multi-link device, MLD operating on multi-links with an Uplink, UL, Traffic IDentifier(TID)-To-Link mapping, the EML mode being applied with a set of EML links:
receiving a Buffer Status Report Poll, BSRP, trigger frame from an AP MLD over a first EML link of the set of EML links;
selecting among the set of EML links an EML link to be used for a frame exchange, as a function of the UL TID-To-Link mapping and of a buffered traffic to be reported in a BSR frame; and
transmitting to the AP MLD, over the first EML link, the BSR frame indicating the selected EML link, which is to be used for the frame exchange.

Thus, an innovative solution is proposed in the non-AP MLD, relying on transmitting a BSR frame indicating a selected EML link to be used for the frame exchange, the selected link being selected as a function of the UL TID-To-Link mapping and of a buffered traffic to be reported in a BSR frame. Due to the fact it takes into account the UL TID-To-Link mapping, this innovative solution allows to avoid or reduce the aforesaid mismatches and inefficiencies between EML modes operations and UL TID-To-Link mapping for TB UL traffic transmission.

In some embodiments, the selected EML link is a second EML link of the set of EML links different from the first EML link over which is received the BSRP trigger frame and transmitted the BSR frame.

In some embodiments, the method further comprises, at the non-AP MLD, after the transmission of the BSR frame: switching a first STA affiliated with the non-AP MLD and corresponding to the selected EML link from a listening operation state or a disabled frame exchange state to an enabled frame exchange state.

In some embodiments, the method further comprises, at the non-AP MLD: over the second EML link, which is different from the first EML link over which is received the BSRP trigger frame, receiving an initial frame triggering a frame exchange sequence on the second link, before receiving a Basic Trigger frame scheduling an UL resource to the non-AP MLD within the frame exchange sequence.

Thus the non-AP MLD can transmit data without mismatches between EML modes operations and Uplink TID-To-Link mapping for TB UL traffic transmission.

In some embodiments, the method further comprises, at the non-AP MLD: selecting the set of EML links as a function of the UL TID-To-Link mapping, and transmitting to the AP MLD a notification specifying the selected set of EML links.

Thus, in the non-AP MLD, transmitting the BSR frame indicating the selected EML link which is to be used for the frame exchange can be combined with taking into account the TID-to-Link mapping in the setup of the EML links for the EML mode.

In some embodiments, the method further comprises, at the non-AP MLD, transmitting to the AP MLD a signaling information indicating which of the two following submodes of the EML mode is to be used:
a first submode of the EML mode, in which, in response to a BSRP trigger frame received from the AP MLD over a given EML link of the set of EML links, the non-AP MLD transmits to the AP MLD, over the given EML link, a BSR frame reporting buffered traffic, if any, of at least one UL TID that is mapped on the given EML link according to the UL TID-To-Link mapping; and
a second submode of the EML mode including said transmission of the BSR frame indicating the selected EML link which is to be used for the frame exchange.

Thus, and as already mentioned above, the non-AP MLD can signal its choice between the aforesaid two submodes of the EML mode.

In some embodiments, the signaling information is contained in a subfield of the EML Control Field of an EML Operation Mode, OM, Notification frame transmitted by the non-AP MLD. Embodiments of the invention also provide a communication method in a wireless network, comprising, at an access point multi-link device, AP MLD, configured to carry out frame exchange operations, with at least one non-AP MLD, operating on multi-links with an Uplink, UL, Traffic IDentifier(TID)-To-Link mapping:
transmitting to the non-AP MLD, over a first enabled link, a Buffer Status Report Poll, BSRP, trigger frame, TF;
receiving from the non-AP MLD, over the first enabled link, a BSR frame reporting buffered traffic; and transmitting to the non-AP MLD, over the first enabled link, a Basic TF scheduling an UL resource to the non-AP MLD and containing a constraint, based on the UL TID-To-Link mapping, on the data to be transmitted within the scheduled UL resource.

Thus, an innovative solution is proposed in the AP MLD, relying on transmitting a Basic TF scheduling an UL resource to the non-AP MLD and containing a constraint, based on the UL TID-To-Link mapping, on the data to be transmitted within the scheduled UL resource. Therefore, it takes into account the UL TID-To-Link mapping to offer TB UL transmissions that are suitable to the non-AP MLDs, thus also allowing to avoid or reduce the aforesaid mismatches and inefficiencies between multi-link mode of operation and UL TID-To-Link mapping for TB UL traffic transmission. This innovative solution applies in particular, but not exclusively, when the multi-link mode of operation is an EML mode (EMLSR mode or EMLMR mode); in this case, said first enabled link is also an EML link.

In some embodiments, the constraint on the data to be transmitted within the scheduled UL resource is indicated by a value of an Access Category, AC, corresponding to UL TIDs that are mapped on the first enabled link according to the UL TID-To-Link mapping.

In some embodiments, the value is indicated in a preferred AC subfield of a Trigger Dependent User Info field of a User Info field corresponding to the scheduled UL resource within the Basic TF.

In some embodiments, the constraint on the data to be transmitted by the non-AP MLD applies if the UL TID-To-Link mapping is a negotiated UL TID-To-Link mapping with a TID-To-Link Mapping Negotiation Supported subfield value equal to 1.

In some embodiments, at least one UL TID is mapped, according to the UL TID-To-Link mapping, on the first enabled link on which is transmitted the BSRP TF.

This feature (about the link used to transmit the BSRP TF) also takes into account the UL TID-To-Link mapping to offer TB UL transmissions that are suitable to the non-AP MLDs, thus also allows to avoid or reduce the aforesaid mismatches and inefficiencies between multi-link mode of operation and UL TID-To-Link mapping for TB UL traffic transmission.

Embodiments of the invention also provide a communication method in a wireless network, comprising, at an access point multi-link device, AP MLD, configured to carry out frame exchange operations, with at least one non-AP MLD, operating on multi-links with an Uplink, UL, Traffic IDentifier(TID)-To-Link mapping:
transmitting to the non-AP MLD, over a first enabled link on which at least one UL TID is mapped according to the UL TID-To-Link mapping, a Buffer Status Report Poll, BSRP, trigger frame, TF.

In other words, the feature about the link used to transmit the BSRP TF (link on which at least one UL TID is mapped) can be implemented independently of the previous feature (Basic TF containing a constraint, based on the UL TID-To-Link mapping, on the data to be transmitted within the scheduled UL resource). This innovative solution applies in particular, but not exclusively, when the multi-link mode of operation is an EML mode (EMLSR mode or EMLMR mode); in this case, said first enabled link is also an EML link. Indeed, the BSRP TF being an initial frame in this case, the frame exchange will take place on the first enabled link (EML link).

In some embodiments, the method further comprises, at the AP MLD, transmitting to the non-AP MLD a signaling information indicating which of the two following submodes of the EML mode is to be used:
a first submode of the EML mode including said transmission of the Basic TF scheduling the UL resource to the non-AP MLD and containing the constraint, based on the UL TID-To-Link mapping, on the data to be transmitted within the scheduled UL resource; and
a second submode of the EML mode, in which the AP MLD retrieves from the BSR frame an indication of a selected EML link to be used for a frame exchange and transmits to the non-AP MLD, over the selected EML link, a Basic TF to trigger an uplink frame exchange with the non-AP MLD on the selected EML link.

Thus, the AP MLD can signal a choice made between the aforesaid two submodes of the EML mode.

Embodiments of the invention also provide a communication method in a wireless network, comprising, at an access point multi-link device, AP MLD configured to carry out frame exchange operations, with at least one non-AP MLD, operating on multi-links with an Uplink, UL, Traffic IDentifier(TID)-To-Link mapping:
receiving from the non-AP MLD, over a first EML link of the set of EML links, a BSR frame in response to a Buffer Status Report Poll, BSRP, trigger frame, TF, transmitted over the first EML link;
retrieving from the BSR frame, an indication of a selected EML link among the EML links, which is to be used for a frame exchange; and
transmitting to the non-AP MLD, over the selected EML link, a Basic TF to trigger an uplink frame exchange with the non-AP MLD on the selected EML link.

Thus, an innovative solution is proposed in the AP MLD, relying on retrieving, from the BSR frame sent by the non-AP MLD, an indication of the selected EML link to be used for a frame exchange. Therefore, it indirectly also takes into account the UL TID-To-Link mapping, thus also allowing to avoid or reduce the aforesaid mismatches and inefficiencies between EML modes operations and UL TID-To-Link mapping for TB UL traffic transmission.

According to features shared by the non-AP MLD and the AP MLD, the selected EML link is implicit to TID(s) reported in the BSR frame, given the UL TID-To-Link mapping. This saves signaling costs in the frame exchanged.

According to features shared by the non-AP MLD and the AP MLD, the reported TID or TIDs are mapped on a second EML link of the set of EML links and not on the first EML link. Hence, there is an implicit and clear signaling that the non-AP MLD requires a frame exchange over the second link, although the BSRP/BSR exchange is conducted on the first link.

According to features shared by the non-AP MLD and the AP MLD: under a negotiated TID-To-Link mapping with TID-To-Link Mapping Negotiation Supported subfield value=1, if the reported TIDs are mapped on the same EML link, the selected EML link to be used for frame exchange is this same EML link.

This configuration solves any ambiguity when several TIDs mapped on several EML links are reported.

According to features shared by the non-AP MLD and the AP MLD: under a default TID-To-Mapping or under a negotiated TID-To-Link mapping with TID-To-Link Mapping Negotiation Supported subfield value=2, the selected EML link to be used for frame exchange is the first EML link over which are transmitted or received the BSRP trigger frame and the BSR frame.

This also removes any ambiguity when the reported TIDs do not allow a single EML link to be identified.

Of course, instead of choosing the first link to remove the ambiguities, the second link may be selected.

According to features shared by the non-AP MLD and the AP MLD: under a negotiated TID-To-Link mapping with TID-To-Link Mapping Negotiation Supported subfield value=1, if at least two reported TIDs are mapped to at least two different EML links, the selected EML link to be used for frame exchange is the first EML link over which are transmitted or received the BSRP trigger frame and the BSR frame.

This again removes any ambiguity in case the reported TIDs do not allow a single EML link to be identified. Instead of choosing the first link to remove the ambiguities, the second link may be selected.

According to features shared by the non-AP MLD and the AP MLD, the selected EML link is explicitly indicated in the BSR frame by a link identifier.

This allows to simplify the processing in the AP MLD.

According to features shared by the non-AP MLD and the AP MLD, the initial frame contains an invitation to other non-AP MLDs to be triggered in an upcoming UL EML frame exchange on the second EML link.

This allows some other EML active non-AP MLDs to be triggered in the upcoming UL EML frame exchange on the second EML link. “Other” may mean different from the non-AP MLDs already triggered by the BSRP frame.

According to features shared by the non-AP MLD and the AP MLD, the initial frame is a Multi User-Request to Send, MU-RTS, frame.

The MU-RTS/CTS procedure, since it uses basic frames which can be decoded by legacy stations, allows the second EML link to be protected before the upcoming UL EML frame exchange.

In some embodiments, the method further comprises, at the AP MLD, transmitting to the non-AP MLD a signaling information indicating which of the two following submodes of the EML mode is to be used:
a first submode of the EML mode including a transmission of a Basic TF scheduling an UL resource to the non-AP MLD and containing a constraint, based on the UL TID-To-Link mapping, on the data to be transmitted within the scheduled UL resource; and
a second submode of the EML mode, in which the AP MLD carries out said retrieving from the BSR frame of an indication of a selected EML link to be used for a frame exchange and said transmitting to the non-AP MLD, over the selected EML link, of a Basic TF to trigger an uplink frame exchange with the non-AP MLD on the selected EML link.

Thus, and as already mentioned above, the AP MLD can signal its choice made between the aforesaid two submodes of the EML mode.

In some embodiments, the signaling information is contained in a subfield of a Common Info Field or in a subfield of a User Info field assigned to the non-AP MLD, within the BSRP TF transmitted by the AP MLD.

A communication method in a wireless network is also provided that comprises, at an access point, AP, affiliated with an AP multi-link device, MLD, and operating on a link for exchanging frames with a non-AP station affiliated with a non-AP MLD, transmitting, over the link, a Basic trigger frame, TF, scheduling an uplink, UL, resource to the affiliated non-AP station and containing a preferred AC subfield in a Trigger Dependent User Info field of a User Info field corresponding to the scheduled UL resource within the Basic TF;
wherein the preferred AC subfield is set to a value for an AC for which at least one corresponding TID is mapped in UL to the link for the non-AP MLD by a Traffic IDentifier(TID)-To-Link mapping.

The TID-To-Link mapping may be negotiated between the AP MLD and the non-AP MLD. Also, the method may further comprise:
transmitting, over the link, a Buffer Status Report Poll, BSRP, trigger frame, TF; and
receiving from the affiliated non-AP station, over the link, a BSR frame reporting buffered traffic.

An access point, AP, is also provided that is affiliated with an AP multi-link device, MLD, and adapted to operate on a link of a wireless network for exchanging frames with a non-AP station affiliated with a non-AP MLD. The affiliated AP comprises:
a transmitter configured to transmit, over the link, a Basic trigger frame, TF, scheduling an uplink, UL, resource to the affiliated non-AP station and containing a preferred AC subfield in a Trigger Dependent User Info field of a User Info field corresponding to the scheduled UL resource within the Basic TF;
wherein the preferred AC subfield is set to a value for an AC for which at least one corresponding TID is mapped in UL to the link for the non-AP MLD by a Traffic IDentifier(TID)-To-Link mapping.

Correlatively, the invention also provides a wireless communication device comprising at least one microprocessor configured for carrying out any method as defined above. The wireless communication device may be either of a non-AP MLD and an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions between EML-capable MLDs in which the present invention may be implemented;

FIGS. 1a and 1b illustrate an exemplary 802.11be multi-link reference model for a MLD either AP MLD or non-AP MLD;

FIG. 2 schematically illustrates an exemplary sequence of frames of the EMLSR

Operating Mode as specified in D2.0 standard;

FIG. 3 illustrates an example of a MAC data frame comprising a Buffer Status Report Control Field (BSR Control field) according to 802.11ax;

FIG. 4a illustrates a generic of a format of a multi-link buffer status report (ML-BSR) dedicated to multi-link devices;

FIG. 4b illustrates a ML-BSR format that is based on the BSR Control field according to 802.11ax as illustrated in FIG. 4a;

FIG. 5a illustrates the EML Capabilities subfields in the Common Info field of a Basic Multi-Link Element as specified in the IEEE P802.11be/D2.0 standard and enriched with a new field according to embodiments of the invention;

FIG. 5b illustrates the format of an EML Control field of an EML OM Notification frame used to activate or deactivate an EML mode as defined in the IEEE P802.11be/D2.0 standard and enriched with a new field according to embodiments of the invention;

FIG. 5c illustrates the format of a Trigger Frame as defined in the IEEE P802.11be/D2.0 standard and enriched with two possible variants of a new field according to embodiments of the invention;

FIG. 6 illustrates, using a flowchart, steps performed by an EML-capable non-AP MLD according to embodiments of the invention;

FIG. 7 illustrates, using a flowchart, corresponding steps performed by the EML-capable AP MLD according to some embodiments of the invention;

FIG. 8 schematically illustrates a first possible operation handled in the flowcharts of FIGS. 6 and 7 using an exemplary sequence of frame exchange between the EML-capable AP MLD and EML-active non-AP MLDs;

FIG. 9 schematically illustrates a second possible operation handled in the flowcharts of FIGS. 6 and 7 using an exemplary sequence of frame exchange between the EML-capable AP MLD and EML-active non-AP MLDs;

FIG. 10 schematically illustrates a variant of the second possible operation illustrated in reference to the FIG. 9 considering the case of EML-active non-AP MLDs having a specific constraint for the transmission of a BSR frame;

FIG. 11 schematically illustrates an EMLSR capable architecture for an MLD to implement embodiments of the invention;

FIG. 12 schematically illustrates an EMLMR capable architecture for an MLD to implement embodiments of the invention; and

FIG. 13 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or STAs. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., STAs). In some aspects, a wireless device or STA implemented in accordance with the teachings herein may comprise an access point (so-called AP) or not (so-called non-AP STA or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP STA may comprise, be implemented as, or known as a subscriber STA, a subscriber unit, a mobile STA (MS), a remote STA, a remote terminal, a user terminal (UT), a user agent, a user device, user equipment (UE), a user STA, or some other terminology. In some implementations, a STA may comprise a cellular telephone, a cordless telephone, a Session Initiation Protocol (“SIP”) phone, a wireless local loop (“WLL”) STA, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA may be a wireless node. Such wireless node may provide, for example, connectivity for or to a network (e.g., a wide area network such as the Internet or a cellular network) via a wired or wireless communication link.

An AP manages a set of STAs (registered to it or associated with it) that together organize their accesses to the wireless medium for communication purposes. The STAs (including the AP to which they register) form a service set, here below referred to as basic service set, BSS (although other terminology can be used). A same physical STA acting as an access point may manage two or more BSS (and thus corresponding WLANs): each BSS is thus uniquely identified by a specific basic service set identification, BSSID and managed by a separate virtual AP implemented in the physical AP. Each STA is identified within a BSS thanks to an identifier, AID, assigned to it by the AP upon registration.

The 802.11 family of standards define various media access control (MAC) mechanisms to drive access to the wireless medium.

The current discussions in the task group 802.11be, as illustrated by draft IEEE P802.11be/D2.0 of May 2022, introduce the Multi-Link Operation (MLO) when it comes to MAC layer operation. The MLO allows multi-link devices to establish or setup multiple links and operate them simultaneously.

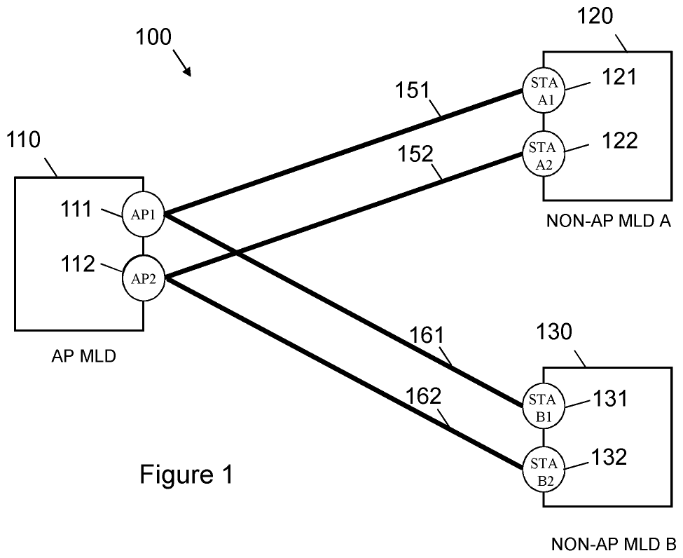

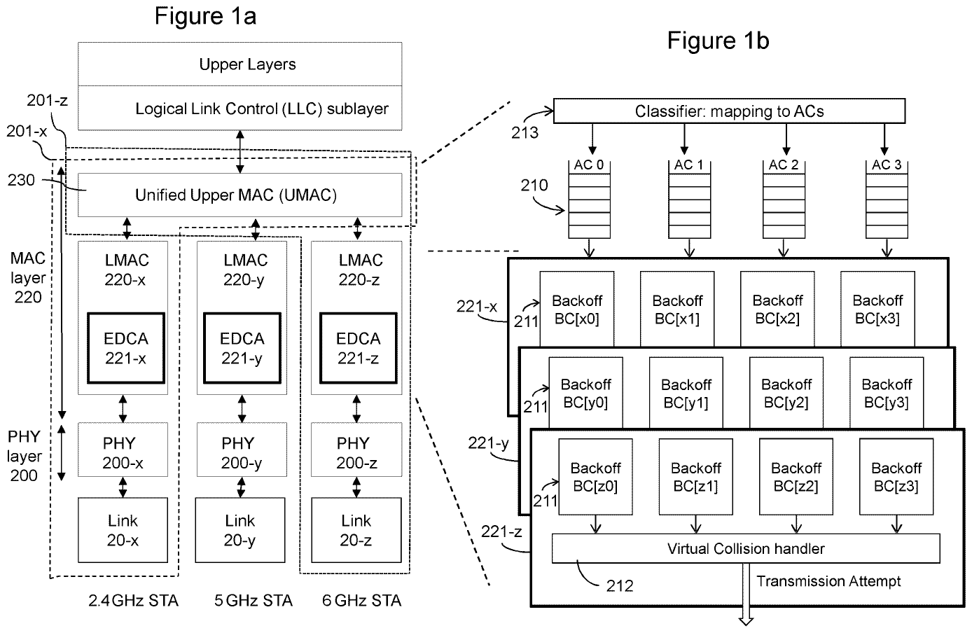

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as “affiliated AP”. A non-Access Point Multi-Link Device (or non-AP MLD) corresponds to a MLD where each STA affiliated with the MLD is a non-AP STA, referred to as “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device. An illustrative architecture of a Multi-Link Device is described below with reference to FIGS. 1a and 1b.

Multiple affiliated non-AP STAs of a non-AP MLD can then setup communication links with multiple affiliated APs of an AP MLD, hence forming a multi-link channel.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHZ, 5 GHZ, 6 GHZ) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated STAs but not necessary a number equal to its number of affiliated STAs. In particular, a non-AP MLD may operate with a number of affiliated STAs greater than its number of radios (which can even be reduced to a single one).

Several Enhanced Multi-Link Operating Modes (or EML OMs in short) have been defined by the D2.0 standard from this physical architecture, namely the Enhanced Multi-Link Single Radio (EMLSR) and the Enhanced Multi-Link Multi Radio (EMLMR). The D2.0 standard states that the two EMLSR and EMLMR modes are mutually exclusive.

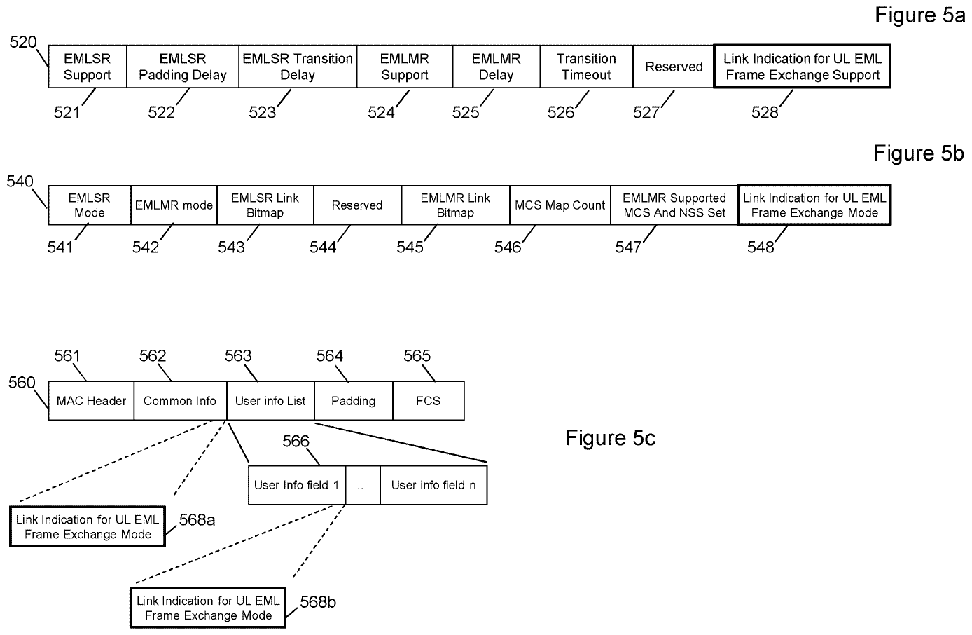

Any non-AP MLD declares its support of the EMLSR and/or EMLMR mode (in its so-called EML Capabilities, see FIG. 5a) to the AP MLD during the association phase. In operation mode, the activation and the deactivation of the EMLSR or EMLMR Mode is initiated by the non-AP MLD which sends a specific EHT action frame referred to as “EML OM Notification”, indicating in particular the set of enabled links (so-called EMLSR or EMLMR links) in which the EMLSR or EMLMR mode to activate is applied (see FIG. 5b). Usually the set “EMLSR/EMLMR links” is made of two enabled links. However, a greater number of enabled links may be used.

The EMLSR mode, once activated, allows the non-AP MLD to simultaneously listen to the enabled links of the set “EMLSR links” to receive initial control frames (e.g. MU-RTS trigger frames or BSRP trigger frames) transmitted by the AP MLD and next to perform data frames exchange with the AP MLD over only one link at a time, usually the link over which the initial control frame is received. The frame exchange sequence initiated by the AP MLD may be either a Triggered Based (TB) Downlink (DL) transmission or a Triggered Based (TB) Uplink (UL) transmission on the link in which the initial control frame was received. Each non-AP MLD may support or not the EMLSR operating mode.

In the EMLMR mode, a non-AP MLD is able to aggregate some physical resources of multiple radios dedicated to multiple enabled links (so-called EMLMR links), in order to transmit or receive data up to a pre-defined number of supported Rx/Tx spatial streams. This predefined number is higher than the number of supported Rx/Tx spatial streams per each radio, hence providing throughput enhancement and latency reduction. As an example, a multi-radio (MR) non-AP MLD supporting the EMLMR mode on two links (with associated radios) communicates over the two links using the two respective radios when the EMLMR mode is deactivated, for example in a 2×2 MIMO antenna configuration for each radio. On the other hand, the MR non-AP MLD communicates over one of the two links using one of its radios with the aggregated physical resources of the two radios (typically the antennas) when the EMLMR mode is activated, for example in a 4×4 MIMO antenna configuration. In the same time, the other link (deprived of its physical antenna) cannot be used.

The EMLMR mode, once activated, allows the non-AP MLD to simultaneously listen to the enabled links of the set “EMLMR links” to receive an initial frame transmitted by the AP MLD to initiate frame exchange and next to perform data frame exchange with the AP MLD over only one EMLMR link (aggregating the radio resources) at a time, usually the link over which the initial frame is received. The frame exchange sequence initiated by the AP MLD may be either a Triggered Based (TB) Downlink (DL) transmission or a Triggered Based (TB) Uplink (UL) transmission on the link in which the initial frame was received.

With the introduction of MLO, the D2.0 standard defines also the Traffic IDentifier(TID)-To-Link mapping mechanism. This mechanism allows an AP MLD and a non-AP MLD that performed or are performing multi-link setup to determine how UL and DL QoS traffic corresponding to TID values between 0 and 7 are assigned to the setup links for the non-AP MLD.

By default, all TIDs shall be mapped to all setup links for both DL and UL, and all setup links are enabled. A non-AP MLD and an AP MLD that performed multi-link setup shall operate under this mode (i.e. default TID-to-Link mapping) if a TID-to-link mapping negotiation for a different mapping did not occur or was unsuccessful or torn down.

The D2.0 standard defines a procedure allowing a TID-To-Link mapping negotiation in DL and/or UL between an initiating MLD and a responding MLD. An MLD may support TID-to-link mapping negotiation. An MLD that supports TID-to-link mapping negotiation has dot11TIDtoLinkMappingActivated equal to true. In a multi-link (re) setup procedure, a non-AP MLD may initiate a TID-to-link mapping negotiation by including the TID-to-link Mapping element in the (Re) Association Request frame. After the multi-link (re) setup, to negotiate a new TID-to-link mapping, an initiating MLD shall send an individually addressed TID-to-link Mapping Request frame to a responding MLD. Then, the responding MLD shall send an individually addressed TID-to-link Mapping Response frame to the initiating MLD to accept the request, reject the request or suggest another TID-to-link mapping. When two MLDs have negotiated a TID-to-link mapping, either MLD may teardown the negotiated TID-to-link mapping by sending an individually addressed TID-to-link Mapping Teardown frame.

In the MLD Capabilities indicated in the Common Info field of a Basic Multi-Link Information Element included, as example, in an (Re) Association Request or Response frame, the TID-To-Link mapping Negotiation Supported subfield indicates the support of TID-To-Link mapping negotiation; the values specified for this 2 bits subfield and the corresponding description are gathered in the table below:

| TID-To-Link | |
|---|---|
| Mapping Negotiation | |
| Supported | |
| subfield values | Description |
| 0 | Set to 0 if dot11TIDtoLinkMappingActivated |
| | is false and TID-to-link mapping is not |
| | supported by the MLD. |
| 1 | Set to 1 if dot11TIDtoLinkMappingActivated |
| | is true and the MLD supports the mapping of |
| | each TID to the same or different link set. |
| 2 | Set to 2 if dot11TIDtoLinkMappingActivated |
| | is true and the MLD only supports the |
| | mapping of all TIDs to the same link set. |
| 3 | The value 3 is reserved. |

An MLD that does not support TID-to-link mapping negotiation has dot11TIDtoLinkMappingActivated equal to false and shall set the TID-to-link Mapping Negotiation Supported subfield to 0. In this case, the default TID-To-Link mapping applies

An MLD that supports TID-to-link mapping negotiation has dot11TIDtoLinkMappingActivated equal to true and shall set to a nonzero value the TID-to-link Mapping Negotiation Supported subfield in the MLD Capabilities and Operations field of the Basic Multi-Link element that it transmits.

If the TID-to-link Mapping Negotiation Supported subfield value received from a peer MLD is equal to 1, the MLD that initiates a TID-to-link mapping negotiation to the peer MLD shall send the TID-to-link Mapping element where each TID is mapped to the same or different link set.

If the TID-to-link Mapping Negotiation Supported subfield value received from a peer MLD is equal to 2, the MLD that initiates a TID-to-link mapping negotiation to the peer MLD shall send only the TID-to-link Mapping element where all TIDs are mapped to the same link set (for example it comprises either all setup links (idem Default mapping) or a subset of setup links).

The description below mostly concentrates on the EMLSR mode for ease of explanation. However, similar considerations can be made with respect to the EMLMR mode.

FIG. 1 illustrates a typical 802.11 network environment involving ML transmissions between EML-capable MLDs (EMLSR and or EMLMR capable) in which the present invention may be implemented.

Wireless communication network 100 involves an AP MLD 110 and two non-AP MLDs 120 and 130. In the example, the two non-AP MLDs are considered to be EML capable and have declared their corresponding capabilities to the AP MLD 110, within the EMLSR-related fields and EMLMR-related fields of the EML Capabilities (these fields are referred to below as EMLSR Capabilities and EMLMR Capabilities, i.e. subparts of the EML Capabilities). Of course, another number of non-AP MLDs registering to the AP MLD 110 and then exchanging frames with it may be contemplated, as well as another (greater) number of EML-capable non-AP MLDs.

AP MLD 110 has multiple affiliated APs, two affiliated APs 111 and 112 (also referenced AP1, AP2 respectively) in the exemplary FIG. 1, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP STAs, each of which behaves as an 802.11 non-AP STA in a BSS (managed by an affiliated AP 111 or 112) to which it registers. In the exemplary FIG. 1, two non-AP STAs 121 and 122 (also referenced A1 and A2 respectively) are affiliated with non-AP MLD 120 and two non-AP STAs 131 and 132 (also referenced B1 and B2 respectively) are affiliated with non-AP MLD 130.

For illustrative purposes, non-AP MLDs 120 and 130 are single-radio non-AP MLDs. For example, AP 111 is set to operate on channel 38 corresponding to an operating 40 MHz channel in the 5 GHz frequency band and AP 112 is set to operate on channel 151 corresponding to another operating 40 MHz channel in the 5 GHz frequency band too. In another example, the affiliated STAs could operate on different frequency bands.

Each affiliated AP offers a link towards the AP MLD 110 to the affiliated non-AP STAs of a non-AP MLD (120 or 130). Hence, the links for each non-AP MLD can be merely identified with the identifiers of the respective affiliated APs. In this context, each of the affiliated APs 111 and 112 can be identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP STA of the non-AP MLD. Each of such links, referred to as “enabled link” enables individual channel access and frame exchanges between the non-AP MLD and the AP MLD based on supported capabilities exchanged during association.

The discovery phase is referred below to as ML discovery procedure, and the multi-link setup phase (or association phase) is referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate setup links between its own affiliated non-AP STAs and some of the discovered affiliated APs and to request the AP MLD 110 to set up these links, which may be accepted or refused by the AP MLD. If the AP MLD accepts, the non-AP MLD is provided with an Association Identifier (AID) by the AP MLD, which AID is used by the affiliated non-APs of the non-AP MLD to wirelessly communicate over the multiple links (communication channels) with their corresponding affiliated APs. During the ML setup procedure, the non-AP MLDs declare part or all of their capabilities. For instance, they may declare their EMLSR capability. For this, appropriate fields are provided in the management frames. In particular, some of the management frames exchanged during the ML discovery and ML setup procedures contains a new Information Elements specific to the Multi-Link Operation (MLO), referred to as Basic Multi-Link element. De facto, in all Management frames that include a Basic Multi-Link element except Authentication frames, a non-AP or AP MLD which is EMLSR capable (dot11EHTEMLSROptionImplemented equal to true) or EMLMR capable (dot11EHTEMLMROptionImplemented equal to true) sets, in the EML Capabilities subfield of the Common Info field, the EMLSR or EMLMR Support bit to 1.

For illustrative purpose, in wireless communication network 100, during the ML setup procedures, two candidate setup links have been requested by non-AP MLD 120 and accepted by AP MLD 110: a first link 151 between affiliated AP 111 (AP1) and affiliated non-AP STA 121 (A1), a second link 152 between affiliated AP 112 (AP2) and affiliated non-AP STA 122 (A2). Similarly, two candidate setup links have been requested by multi-radio non-AP MLD 130 and accepted by AP MLD 110: a first link 161 between affiliated AP 111 (AP1) and affiliated non-AP STA 131 (B1), a second link 162 between affiliated AP 112 (AP2) and affiliated non-AP STA 132 (B2).

AP MLD 110, non-AP MLD 120 and non-AP MLD 130 are considered as EMLSR capable (dot11EHTEMLSROptionImplemented equal to true) or EMLMR capable (dot11EHTEMLMROptionImplemented equal to true). They exchange their EMLSR or EMLMR capabilities (subparts of the EML Capabilities) during their ML discovery procedure and the multi-link setup phase.

As currently defined in the D2.0 Standard, the EMLSR and EMLMR Capabilities include the following subfields:
the “EMLSR Support” subfield indicating support of the EMLSR operation for the MLD. The EMLSR Support subfield is set to 1 if the MLD supports the EMLSR operation; otherwise it is set to 0;
the “EMLSR Padding Delay” 3-bit subfield indicating the minimum MAC padding duration of the Padding field of the initial Control frame requested by the non-AP MLD as defined in the Enhanced multi-link single radio operation (section 35.3.17). A table converts the 3-bit values into padding delays in μs. This delay is used to define the transition period needed by the MLD to switch the state of its affiliated stations from the listening operation state to the enable/disable frame exchange states. This transition period is made of this delay added to the time length of an Initial Control frame response as described below. This transition period is therefore referred to as “EMLSR active switch delay” below;
the “EMLSR Transition Delay” 3-bit subfield indicating the transition delay time needed by a non-AP MLD to switch from so-called frame exchange modes (on one of the enabled links) to the so-called listening operation mode on the enabled links. A table converts the 3-bit values into delays in μs. For instance, it is set to 0 for 0 μs, set to 1 for 16 μs, 2 for 32 μs, set to 3 for 64 μs, set to 4 for 128 μs, set to 5 for 256 μs, and the values 6 to 7 are reserved;
the “EMLMR Support” subfield indicating support of the EMLMR operation for the MLD. The EMLMR Support subfield is set to 1 if the MLD supports the EMLMR operation;
otherwise, it is set to 0;
the “EMLMR Delay” 3-bit subfield indicating the minimum padding duration required for a non-AP MLD for EMLMR link switch when operating in the EMLMR mode. This delay is used to define the transition periods needed by the MLD to switch the state of its affiliated stations when starting or ending a frame exchange; The transition period for the start of a frame exchange is made of this delay added to the time length of an Initial frame response as described below. This start transition period is therefore referred to as “EMLMR active switch delay” below;
the “Transition Timeout” subfield indicating the timeout value for EML Operating Mode Notification frame exchange in EMLSR (or EMLMR).

When a non-AP MLD which is EMLSR (resp. EMLMR) capable intends to operate in the corresponding mode on a set of enabled links, referred to as EMLSR (resp. EMLMR) links, a STA affiliated with the non-AP MLD transmits an EML Operating Mode (OM) Notification frame (specified in D2.0 standard) with the EMLSR (resp. EMLMR) Mode subfield of the EML Control field set to 1 to an AP affiliated with an AP MLD which is EMLSR (resp. EMLMR) capable (here AP MLD 110). The EMLSR (resp. EMLMR) links are indicated in the EMLSR (resp. EMLMR) Link Bitmap subfield of the EML Control field of the EML OM Notification frame by setting the bit positions of the EMLSR (resp. EMLMR) Link Bitmap subfield to 1 for each of the EMLSR (resp. EMLMR) links. For example, in the EMLSR (resp. EMLMR) Bitmap, the bit position i corresponds to the link with the Link ID equal to i and is set to 1 to indicate that the link is a member of the EMLSR (resp. EMLMR) links.

The AP affiliated with the AP MLD that received the EML Operating Mode Notification frame from the STA affiliated with the non-AP MLD next transmits an EML Operating Mode Notification frame to one of the STAs affiliated with the non-AP MLD within the timeout interval indicated in the Transition Timeout subfield in the EML Capabilities subfield of the Basic Multi-Link element starting at the end of the PPDU transmitted by the AP affiliated with the AP MLD as an acknowledgement to the EML Operating Mode Notification frame transmitted by the STA affiliated with the non-AP MLD.

After the successful transmission of the EML Operating Mode Notification frame on one of the EMLSR (resp. EMLMR) links by the STA affiliated with the non-AP MLD, the non-AP MLD operates in the EMLSR (resp. EMLMR) mode, it is considered as EMLSR-active (resp. EMLMR-active).

When a non-AP MLD which is EMLSR capable intends to disable the EMLSR (resp. EMLMR) mode, a STA affiliated with the non-AP MLD transmits an EML Operating Mode (OM) Notification frame (specified in D2.0 standard) with the EMLSR (resp. EMLMR) Mode subfield of the EML Control field set to 0 to an AP affiliated with the AP MLD. Again, an AP affiliated with the AP MLD that received the EML Operating Mode Notification frame from the STA affiliated with the non-AP MLD transmits an EML Operating Mode Notification frame as above as an acknowledgement to the EML Operating Mode Notification frame. After the successful transmission of the EML Operating Mode Notification frame on one of the EMLSR (resp. EMLMR) links by the STA affiliated with the non-AP MLD, the non-AP MLD disables the EMLSR (resp. EMLMR) mode.

The set of STAs affiliated with an EMLSR (resp. EMLMR) capable non-AP MLD operating on the EMLSR (resp. EMLMR) links may be all or part of the STAs affiliated with the non-AP MLD. The STAs of this set are referred below to “EMLSR co-affiliated STAs” (resp. EMLMR co-affiliated STAs) for the non-AP MLD.

In the example of FIG. 1, the EMLSR co-affiliated STAs of non-AP MLD 120 and of non-AP MLD 130 operate on the same links (i.e. with the same affiliated APs, AP1 and AP2) meaning they share the same EMLSR links.

FIG. 1a illustrates an exemplary 802.11be multi-link reference model for a MLD either AP MLD or non-AP MLD.

The MLD comprises a PHY layer 200, a MAC layer 220, a logical link control (LLC) sublayer and upper layers.

Upper layers may include applications that generate traffic data or use received traffic data.

The transmission and the reception of the traffic data are handled by the MAC 220 and PHY 200 layers. Such transmission and reception of the traffic data may take place over multiple links 20-x, 20-y, 20-z, as the ones 151, 152, 161, 162 introduced with reference to FIG. 1. Three links and therefore three affiliated stations are shown. Of course, other configurations including two affiliated stations or more than three affiliated stations may be contemplated.

The traffic data are provided by the upper layers as a sequence of data frames, or “traffic stream”. Each traffic stream and thus each data frame are associated with an access category (AC) as defined in the EDCA mechanism (FIG. 1b). This mapping between the streams or data frames and the ACs is made by a classifier 213.

It is recalled that an 802.11 station (AP and non-AP station) maintains four Access Categories (ACs), each having one or more corresponding transmit buffers or queues. The four ACs are conventionally defined as follows:
AC1 and AC0 are reserved for best effort and background traffic. They have, respectively, the penultimate lowest priority and the lowest priority.
AC3 and AC2 are usually reserved for real-time applications (e.g., voice or video transmission). They have, respectively, the highest priority and the penultimate highest priority. The data frames, also known as MAC service data units (MSDUs), incoming from an upper layer of the protocol stack are mapped, by classifier 213, onto one of the four ACs and thus input in a queue of the mapped AC.

FIG. 1b illustrates an implementation model with four transmit queues, one per access category.

The 802.11be multi-link reference model reflects the fact that MLDs may transmit and receive using several links, particularly at the level of the MAC layer 220 and the PHY layer 200.

The MAC layer 220 comprises one Unified Upper-MAC (UMAC) layer 230, multiple Lower-MAC (LMAC) layers 220-x, 220-y, 220-z coupled with a respective PHY layer 200-x, 200-y, 200-z, each couple corresponding to a link 20-x, 20-y, 20-z.

The UMAC 230 performs functionalities that are common across all links and each LMAC 220-x, 220-y, 220-z performs functionalities that are local to each link 20-x, 20-y, 20-z. The UMAC layer then offers a UMAC interface with the link-specific blocks 220-x, 220-y, 220-z and also provides a UMAC Service Access Point (SAP) to the LLC and upper layers.

The UMAC 230 is responsible for link-agnostic MAC procedures such as authentication, association, security association, sequence number assignments, MAC Protocol Data Unit (MPDU) encryption/decryption, aggregation/de-aggregation, acknowledgement score boarding procedure, etc.

Each data unit, MSDU, arriving at the MAC layer 220 from an upper layer (e.g. Link layer) with a type of traffic (User Priority (UP), hence Traffic IDentifer (TID)) priority is mapped onto one of the ACs according to the mapping rule at the UMAC layer 230. Then, still at the UMAC layer 230, the data unit, MSDU, is provided with the next sequence number available and is stored in the queue corresponding to its TID (or UP) within the mapped AC. It is recalled that an 802.11 station maps the TIDs onto ACs as follows (TIDx refers to TID=x):
TID1 and TID2 are mapped onto AC0 used typically for background traffic,
TID0 and TID3 are mapped onto AC1 used typically for best effort traffic,
TID4 and TID5 are mapped onto AC2 used typically for video traffic,
TID6 and TID7 are mapped onto AC3 used typically for voice traffic.

Each LMAC 220-x, 220-y, 220-z is in charge of link specific functionalities, as the channel access. In particular, each MLD Lower MAC includes its own contention-based channel access procedure, e.g. EDCA 221-x, 221-y, 221-z. Some of the functionalities require joint processing of both the UMAC 230 and LMACs 220-x, 220-y, 220-z.

As illustrated in FIGS. 1a and 1b, each EDCA 221-x, 221-y, 221-z per link performs contention per link for each AC queue. In that respect, each AC has its own set of queue contention parameters (i.e. EDCA access parameters) per link, and is associated with a priority value, hence defining traffics of higher or lower priority of MSDUs. Thus, there is a plurality of traffic queues for serving data traffic at different priorities for a given link. The arbitration inter-frame space (AIFSn), the contention window (CW) and the backoff values are known as being EDCA access parameters, and are specialized for each AC on each link 20-x, 20-y, 20-z.

For an MLD, each AC or traffic queue 210 is mapped onto one EDCA engine 221 per link. Thus, each backoff entity 211 of an EDCA engine 221 dedicated to a link is associated with a respective AC queue 210 for using queue contention parameters and drawing a backoff value to initialize a respective queue backoff counter (BC) specialized per AC and per link. In FIG. 1b, backoff counters BC [x0], BC [x1], BC [x2], BC [x3] are respectively associated with traffic queues 210 of AC0, AC1, AC2, AC3 and will be used, concurrently, to contend for access to link 20-x. Similarly, backoff counters BC [y0], BC [y1], BC [y2], BC [y3] are respectively associated with traffic queues 210 of AC0, AC1, AC2, AC3 and will be used, concurrently, to contend for access to link 20-y. Similarly, backoff counters BC [z0], BC [z1], BC [z2], BC [z3] are respectively associated with traffic queues 210 of AC0, AC1, AC2, AC3 and will be used, concurrently, to contend for access to link 20-z.

A backoff counter is used to contend for access to the link 20-x, 20-y or 20-z in order to transmit data stored in the queue of the AC. Practically, the backoff counter is decremented from its initialization value when the medium is idle, and the corresponding affiliated STA 201-x, 201-z is allowed to transmit (access granted) when the backoff counter reaches 0.

When the access to the wireless medium is granted for an AC on a given link, MSDUs stored in the traffic queue 210 corresponding to that AC are transmitted to the physical (PHY) layer 200-x, 200-y, 200-z for transmission over the given link.

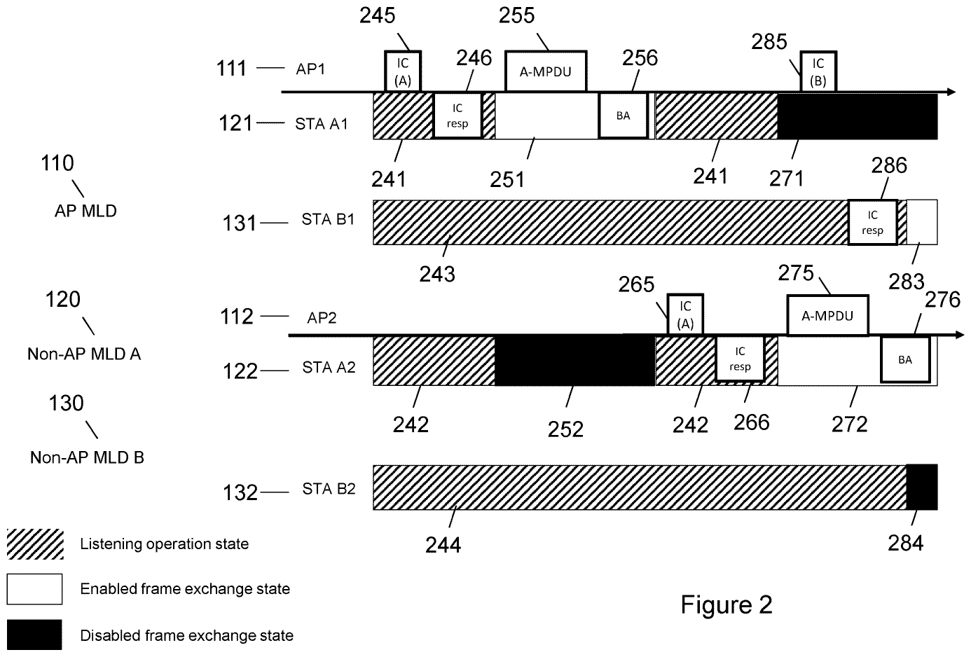

FIG. 2 illustrates, using a frames sequence, the EMLSR Operating Mode in non-AP MLD 120 when AP MLD 110 decides to use the EMLSR mode. Of course, although the EMLSR mode is emphasized here by way of example, similar considerations can be made with respect to the EMLMR mode.

In this sequence, the non-AP MLDs operate in the EMLSR mode, meaning EML Operating Mode Notification frames activating the EMLSR mode have been successfully transmitted by affiliated STAs of the non-AP MLD 120. In other words, it has entered an active Enhanced Multi-Link Single Radio, EMLSR, mode applying to a specific set of two or more enabled links.

The affiliated STAs 121 and 122 are EMLSR co-affiliated STAs within non-AP MLD 120. Each affiliated STA can be in one of three defined states: listening operation state, enabled frame exchange state and disabled frame exchange state.

Non-AP MLD 120 is able to listen simultaneously on its EMLSR links, by having its EMLSR co-affiliated STA(s) corresponding to those links in “awake” or “listening operation” state. For example, affiliated STAs A1, A2 are in the listening operation state (referenced 241 and 242). The listening operation includes CCA (Clear Channel Assessment) and receiving an initial Control frame of frame exchanges that is initiated by the AP MLD. In non-AP MLD 120, the two EMLSR co-affiliated STAs therefore simultaneously listen for receiving the initial Control frame from the AP MLD.

When the AP MLD 110 intends to initiate frame exchanges with one or more non-AP MLDs on one of the EMLSR links, it begins the frame exchanges by transmitting the initial Control frame 245 which explicitly triggers the non-AP MLD. To a certain extent, the initial Control frame schedule the non-AP MLD. The initial Control frame of frame exchanges is sent in the OFDM PPDU or non-HT duplicate PPDU format using a rate of 6 Mbps, 12 Mbps, or 24 Mbps (i.e. MCS subfield in the frame set to a value up to 2). As defined in the D2.0 Standard, the initial Control frame shall be a MU-RTS Trigger frame or a BSRP Trigger frame as defined in IEEE Std 802.11ax™-2021. Given the trigger frame format according to which such a frame includes one or more User Info fields, this condition means frame 245 includes a User Info field addressed to the non-AP MLD, i.e. where an AID12 field is set to the AID of the non-AP MLD (obtained upon registration).

In the present example and as shown by reference “IC (A)”, the initial Control frame 245 explicitly triggers non-AP MLD A 120. The initial Control frame may explicitly trigger multiple non-AP MLDs using multiple User Info fields therein.

The EMLSR co-affiliated STA of the non-AP MLD explicitly triggered by the initial Control frame 245 that receives the frame, e.g. affiliated STA A1 in the example, initiates a state change of the EMLSR co-affiliated STA of the non-AP MLD considered, e.g. a change of the states of affiliated STAs A1 and A2 in the example, and sends an Initial Control frame response (IC resp.) 246 to the AP AP1 affiliated with the AP MLD 110.

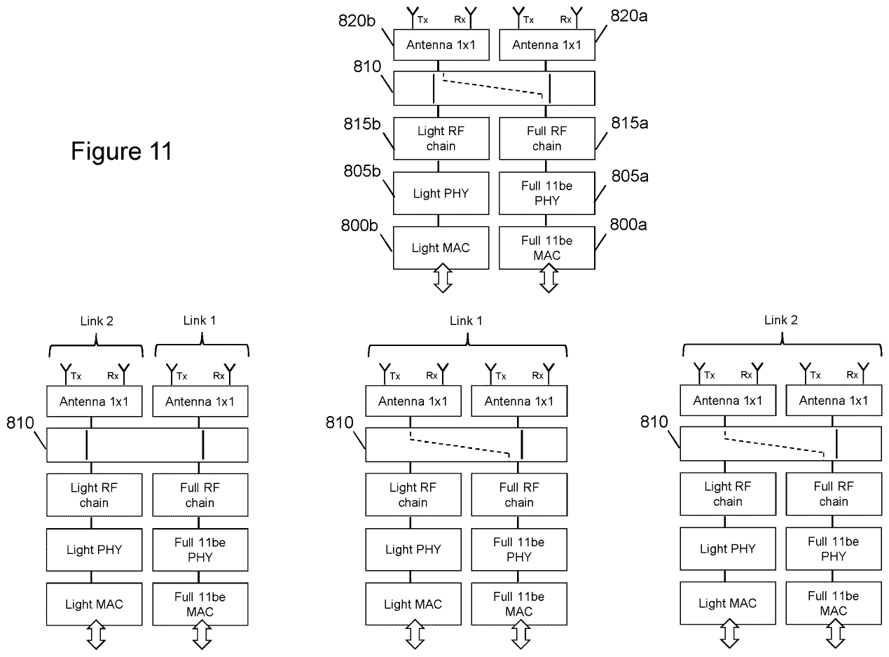

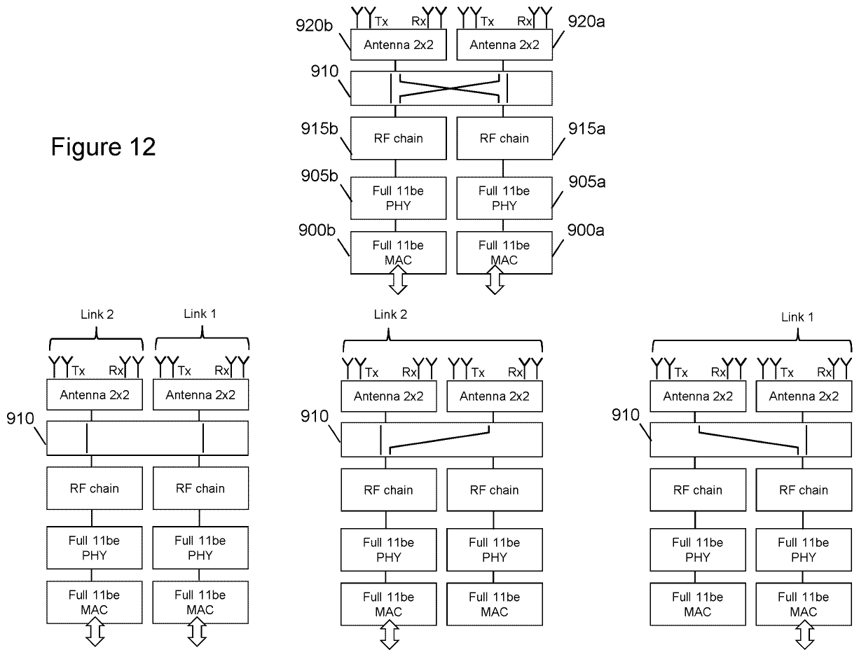

After receiving the initial Control frame of frame exchanges 245 and transmitting an immediate response frame 246 as a response to the initial Control frame, the STA affiliated with the non-AP MLD that was listening on the corresponding link, i.e. the receiving EMLSR co-affiliated STA A1 in the example, is configured to be able to transmit or receive frames on the enabled link in which the initial Control frame 245 was received, i.e. link 151 in the example. To do so, a state switching procedure is invoked upon receiving frame 245, which results in having the receiving EMLSR co-affiliated STA being switched, after an EMLSR active switch delay, from the listening operation state 241 to an “active frame exchange” or “enabled frame exchange” state, referenced 251 in the Figure. The receiving EMLSR co-affiliated STA in this new state is capable of receiving a PPDU that is sent using more than one spatial stream on the link in which the initial Control frame 245 was received. The EMLSR active switch delay corresponds to the delay time needed by a non-AP MLD to switch from the EMLSR listening operation mode to the EMLSR frame exchange mode. As mentioned above, it derives from indication specified in the EML Capabilities (through the EMLSR Padding Delay) exchanged with the AP MLD: it is the EMLSR Padding Delay added to the time length of Initial Control frame response 246. Simultaneously, the other EMLSR co-affiliated STAs of the same non-AP MLD, i.e. STA A2 in the example, are configured not to transmit or receive on the other EMLSR link(s) until the end of the frame exchanges. To do so, a state switching procedure is also invoked for the other EMLSR co-affiliated STAs which in turn are switched from the listening operation state 242 to a “blindness frame” or “disabled frame exchange” state, referenced 252 in the Figure. In particular, no data is transmitted by the AP MLD intended to these other EMLSR co-affiliated STAs. The state switches of all the EMLSR co-affiliated STAs within the same non-AP MLD are inseparable, hence simultaneous, because it is a question of allocating a full radio resource chain (see FIG. 11 below) to one of the STAs while the others are deprived of such chain. With respect to the EMLMR mode, the physical resources (e.g. antennas) of one radio resource chain are allocated (and aggregated) to the other radio resource chain, the former being therefore deprived of transmission/reception capabilities (see FIG. 12 below).

The above shows that when a non-AP MLD operates in the EMLSR mode (and more generally in any of the EMLSR and EMLMR mode), it is either in a listening operation mode (its co-affiliated STAs are in the listening operation state) or in a frame exchange mode (one of its co-affiliated STAs is in the enabled frame exchange state while the other co-affiliated STAs are in the disabled frame exchange state).

It turns out that only one of the EMLSR co-affiliated STAs of an explicitly triggered non-AP MLD can perform data frames exchange at a time with the AP MLD; this is usually the EMLSR co-affiliated STAs which received the initial Control frame 245.

An exemplary frame exchange sequence is shown in the Figure that includes the sending of an A-MPDU frame 255 (hence downlink transmission) by the affiliated AP AP1 to the EMLSR co-affiliated STA A1 of explicitly triggered non-AP MLD A 120, followed by a corresponding block acknowledgment 256 from the latter.

After the end of the frame exchanges operated by the receiving EMLSR co-affiliated STA plus an EMLSR Transition Delay as specified in the EML capabilities, the non-AP MLD 120 switches back to the EMLSR listening operation state, meaning that the receiving EMLSR co-affiliated STA A1 switches back to the listening operation state 241 as well as the other EMLSR co-affiliated STA A2 (listening operation state 242). A state switching procedure is therefore invoked for each of the EMLSR co-affiliated STAs.

An end of frame exchanges can be sensed by a non-AP MLD, here non-AP MLD 120, if one of the following conditions is met:

(1) The MAC of the STA affiliated with the non-AP MLD that received the initial Control frame 245 does not receive a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement. This represents the end of an actual exchange with the AP MLD, without receiving a subsequent frame from the latter.

(2) The MAC of the STA affiliated with the non-AP MLD that received the initial Control frame 245 receives a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement, and the STA affiliated with the non-AP MLD does not detect, within the PPDU corresponding to the PHY-RXSTART.indication any of the following frames:
an individually addressed frame with the RA equal to the MAC address of the STA affiliated with the non-AP MLD,
a Trigger frame that has one of the User Info fields addressed to the STA affiliated with the non-AP MLD,
a CTS-to-self frame with the RA equal to the MAC address of the AP affiliated with the AP MLD,
a Multi-STA BlockAck frame that has one of the Per AID TID Info fields addressed to the STA affiliated with the non-AP MLD,
a NDP Announcement frame that has one of the STA Info fields addressed to the STA affiliated with the non-AP MLD.

This corresponds to the case where, after an actual exchange with the AP MLD, the non-AP MLD receives another frame from the AP MLD which is not addressed to it (i.e. no data is addressed to it or no resource is allocated to it).

(3) The STA affiliated with the non-AP MLD that received the initial Control frame 245 does not respond to the most recently received frame (e.g. A-MPDU frame 255) from the AP affiliated with the AP MLD that requires immediate response after a SIFS.

As non-AP MLD 120 is now in the EMLSR listening operation mode, the AP MLD may initiate any new frame exchange sequence (with either of non-AP MLD 120 or 130) by transmitting a new initial Control frame.

In the example of the Figure, the AP MLD 110 decides to initiate such a new sequence with non-AP MLD 120 again, using its EMLSR co-affiliated STA A2 122. In details, the AP MLD 110 using its other affiliated AP 112 transmits a new Initial Control frame 265 IC(A) explicitly triggering the non-AP MLD A 120, which frame is now received by the EMLSR co-affiliated STA A2 122. The receiving EMLSR co-affiliated STA A2 122 transmits a response frame 266 to the Initial Control frame 265. After an EMLSR active switch delay, the explicitly triggered non-AP MLD 120 switches to EMLSR frame exchange mode where the receiving EMLSR co-affiliated STA A2 122 switches from the listening operation state 242 to the enabled frame exchange state 272 while its other EMLSR co-affiliated STA A1 121 simultaneously switches from the listening operation state 241 to the disabled frame exchange state 271. Frames 275, 276 are then exchanged during the frame exchange sequence, up to the end of the sequence where the non-AP MLD 120 switches back to the EMLSR listening operation mode.

A-MPDU 255/275 is only provided as an illustration. Other types of frames can be sent by the AP MLD, e.g. basic Trigger frames to trigger UL transmissions. Although FIG. 2 shows frame exchanges made of a single frame 255/275 followed by an acknowledgment 256/276, simpler frame exchanges may only comprise a single frame sent by the AP MLD without acknowledgment, while more complex frame exchanges may comprise multiple sequences of exchanges, e.g. cascaded TXOPs for UL transmissions (triggered by a basic Trigger frame) and/or for DL transmissions (through an HE MU PPDU).

This illustrative example shows the advantages of the EMLSR mode in terms of throughput and latency: the AP MLD may switch quickly from one link to another link, hence improving communication performances for a limited increase of complexity and cost.

As mentioned above, the preceding description also applies to the EMLMR mode with, inter alia, the following matchings: the EMLMR Delay applies for both EMLSR Padding Delay and EMLSR Transition Delay; the initial frame in the EMLMR mode matches the initial control frame in the EMLSR mode and similarly the initial frame response in the EMLMR mode matches the initial control frame response in the EMLSR mode; although not defined in the D2.0 Standard, an EMLMR listening operation state/mode can be defined that matches the EMLSR listening operation state/mode where the co-affiliated STAs are listening to their links before aggregation of physical radio resources.

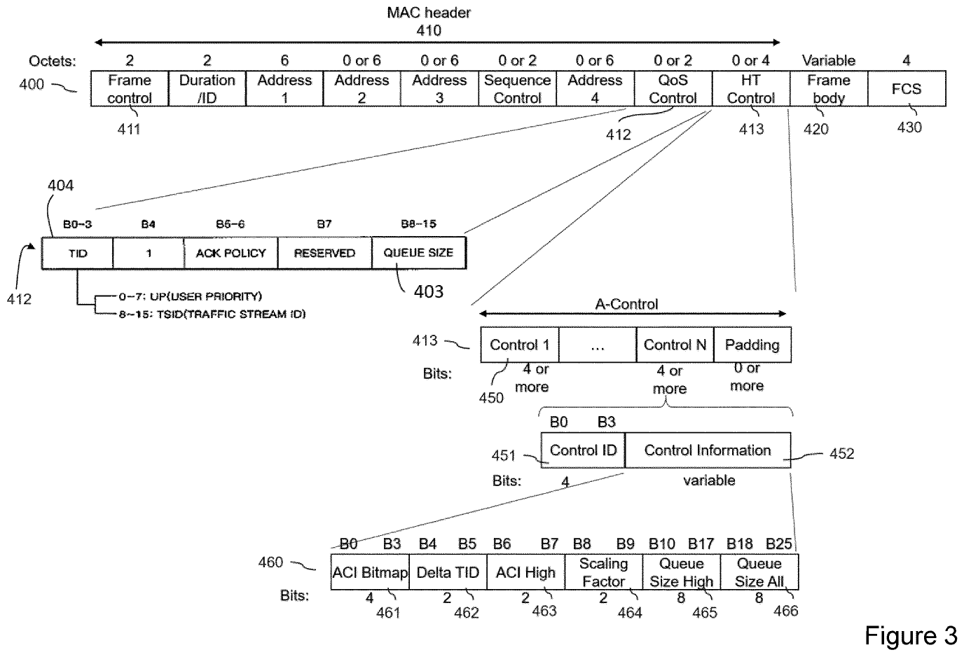

FIG. 3 illustrates an example of a MAC data frame comprising a Buffer Status Report Control Field (BSR Control field) according to 802.11ax

The illustrated MAC data frame 400 comprises a MAC header 410, a frame body 420 and a FCS field 430. The MAC header 410 includes, amongst other fields, a Frame Control header 411, a QoS control field 412 and a HT control field 413. The QoS control field 412 is the original 802.11e format that may be used by a non-AP station of any 802.11 technology to report a buffer status. Alternatively, or possibly additionally, a non-AP station starting from 802.11ax version (including further releases such as 802.11be/EHT) may use the HT control field 413 to do so.

Thus, the field 413 may be indifferently referred to as HT or HE or EHT Control field according to the 802.11 generation considered (respectively 802.11ac, 802.11ax or 802.11be) when provided inside the 802.11 MAC Data Frame 400.

### 802.11 Legacy BSR Format:

As illustrated, the QoS control field 412 is made of two bytes, including the following information items:
Bits B0 to B3 are used to store a traffic identifier (TID) 404 which identifies a traffic stream. The traffic identifier takes the value of the transmission priority value (User Priority UP, value between 0 and 7) corresponding to the data conveyed by the data frame or takes the value of a traffic stream identifier, TSID, value between 8 and 15, for other data streams;
Bit B4 is used by a non-AP station to differentiate the meaning of bits B8-B15 and is detailed here below;
Bits B5 and B6 define the ACK policy subfield which specifies the acknowledgment policy associated with the data frame. This subfield is used to determine how the data frame has to be acknowledged by the receiving station; normal ACK, no ACK or Block ACK.
Bit B7 is reserved, meaning not used by the current 802.11 standards; and
If bit B4 is set to 1, bits B8-B15 represent the “queue size” subfield 403, to indicate the amount of buffered traffic for the TID 404 specified in bits B0-B3 at the non-AP station sending this frame. The queue size value is the total size, rounded up to the nearest multiple of 256 octets and expressed in units of 256 octets, of all packets buffered for the specified TID. The access point may use this information to determine the next TXOP duration it will grant to the station. A queue size of 0 indicates the absence of any buffered traffic for that TID. A queue size of 255 indicates an unspecified or unknown size for that TID 404.
Alternatively to the “queue size” usage, if bit B4 is set to 0, bits B8-B15 represent the “TXOP Duration Requested” subfield. It indicates the duration, in units of 32 μs that the sending station determines it needs for its next TXOP for the specified TID. Of course, the “TXOP Duration Requested” provides an equivalent request as the “queue size”, as they both consider all packets buffered for the specified TID.

The following description will be done with “queue size” format for the buffer status reports, as it is the largest usage (the “TXOP Duration Requested” format is deprecated for Multi User usage). The 802.11e MAC frame format, and more particularly the QoS Control field 412, have been kept for the up and corner standard versions as now described.

The legacy BSR according to 802.11e can handle one TID report per MSDU frame, this is one reason why enhancements were later provided by 802.11ax version.

### 802.11ax BSR Format:

The HT-Control field 413 may aggregate multiple (N in the Figure) control fields, resulting in a sequence of one or more Control subfields 450. The length of the aggregated control field (A-Control field) 413 is equal to 30 bits.

Each Control subfield 450 includes a Control ID 451 subfield indicating the type of information carried in the Control Information subfield 452 that follows. Padding bits are added if necessary to reach the 30 bits of the A-Control field.

Various type of information may thus be provided through the A-Control field 413 depending on the Control ID 451. For instance, operating modes may be indicated in Control Information subfield 452 when Control ID 451 is 1. Also, power data may be indicated in Control Information subfield 452 when Control ID 451 is 4.

If Control ID subfield 451 is 3, Control Information subfield 452 of the Control subfield 450 contains buffer status information in the format of a BSR control field shown in the Figure under reference 460.

A non-AP station may report the buffer status for a preferred AC or for all AC queues. The Buffer Status Information 460 is made up of six subfields: ACI Bitmap 461, Delta TID 462, ACI High 463, Scaling Factor 464, Queue Size High 465 and Queue Size All 466.

A number N_{TID} of traffic identifiers for which there is buffered uplink, UL, traffic, is signaled using the first two subfields in the BSR control field 460, namely ACI Bitmap 461 and Delta TID 462.

ACI Bitmap subfield 461 has four bits and indicates the access categories for which the buffer status is reported. Each bit of the ACI Bitmap subfield 461 is associated with one of the four ACs and is set to 1 to indicate that the buffer status of the corresponding AC is included in the Queue Size All subfield 466, otherwise it is set to 0.

Exception is made for the particular case where the buffer statuses for all eight TIDs are included in the Queue Size All subfield 466. In that case ACI Bitmap subfield=0 is combined with Delta TID subfield 462 set to 3.

Delta TID subfield 462 together with the values of the ACI Bitmap subfield, indicate the number of TIDs for which the non-AP station is reporting the buffer status. The table below gives the relationships between these two subfields and the number of TIDs. The table comes from table 9-24e of document 802.11ax, version 8.0.

| Number N_{bit} of | |
|---|---|
| bits in ACI | |
| Bitmap subfield | |
| 461 that | Mapping of Delta TID subfield value and number |
| are set to 1 | of TIDs, N_{TID} |
| 0 | Values 0 to 2 are not applicable; |
| | Value 3 indicates 8 TIDs (i.e., all ACs have traffic) |
| 1 | Value 0 indicates 1 TID; Value 1 indicates 2 TIDs; |
| | Values 2 to 3 are not applicable; |
| 2 | Value 0 indicates 2 TIDs; Value 1 indicates 3 TIDS; |
| | Value 2 indicates 4 TIDs; Value 3 is not applicable; |
| 3 | Value 0 indicates 3 TIDs; Value 1 indicates 4 TIDs; |
| | Value 2 indicates 5 TIDs; Value 3 indicates 6 TIDs; |
| 4 | Value 0 indicates 4 TIDs; Value 1 indicates 5 TIDS; |
| | Value 2 indicates 6 TIDs; Value 3 indicates 7 TIDs; |

ACI High subfield 463 is used to indicate the ACI (Access Control Identifier) of a preferred AC for which the amount of buffered traffic is specified in Queue Size High subfield 465.

Scaling Factor subfield 464 indicates the unit SF, in octets, of Queue Size High and Queue Size All subfields 465, 466.

Queue Size High subfield 465 indicates the amount of buffered traffic, in units of SF octets, for the AC identified by ACI High subfield 463 that is intended for the station (usually the AP) identified by the receiver address of the MAC frame 400.

Queue Size All subfield 466 indicates the amount of buffered traffic, in units of SF octets, for all the ACs identified by ACI Bitmap subfield 461 that is intended for the station (usually the AP) identified by the receiver address of the MAC frame 400.

The queue size values set in Queue Size High and Queue Size All subfields 465, 466 are the total sizes, rounded up to the nearest multiple of SF octets, of all MSDUs and A-MSDUs buffered at the non-AP station reporting its buffer statuses.

The standardized 802.11ax BSR remains dedicated to the reporting of buffer statuses from one (or several) of the 4 queues. This format is no longer compliant with TID values greater than 7, whereas the legacy format is still. For instance, upper layers may provide data frame, MSDU, with 802.1D User Priority (UP) values taken in the reserved 8-15 values (known as TSID) for low latency delivery services.

Current BSR procedure provides a protocol for AP to acquire buffer status of each AC, i.e. each traffic, on the non-AP side, so that AP can send trigger frames to trigger UL traffic. Therefore, current BSR approach enables a non-AP MLD to provide the AP MLD with its transmission needs globally, without considering that the AP MLD is able to schedule data transmission on link basis.

However, when scheduling over links, the AP MLD does not have precise information relating to the links, and for example the AP MLD may not be aware of disturbances on some links. Indeed, when choosing a link, the AP MLD does not offer any guarantee regarding the latency, reliability or jitter of the transmission, which mainly depends on radio reception at the non-AP MLD side.

Indeed, the non-AP MLD is well aware of its radio environment such that, knowing that some radio links are experiencing disturbances, the non-AP MLD is in a better position to determine the optimal link for data transmission at a given time.

Thus, the AP MLD, which only considers the competition between the stations, may sometimes give an uplink transmission opportunity to the station on an unsuitable link.

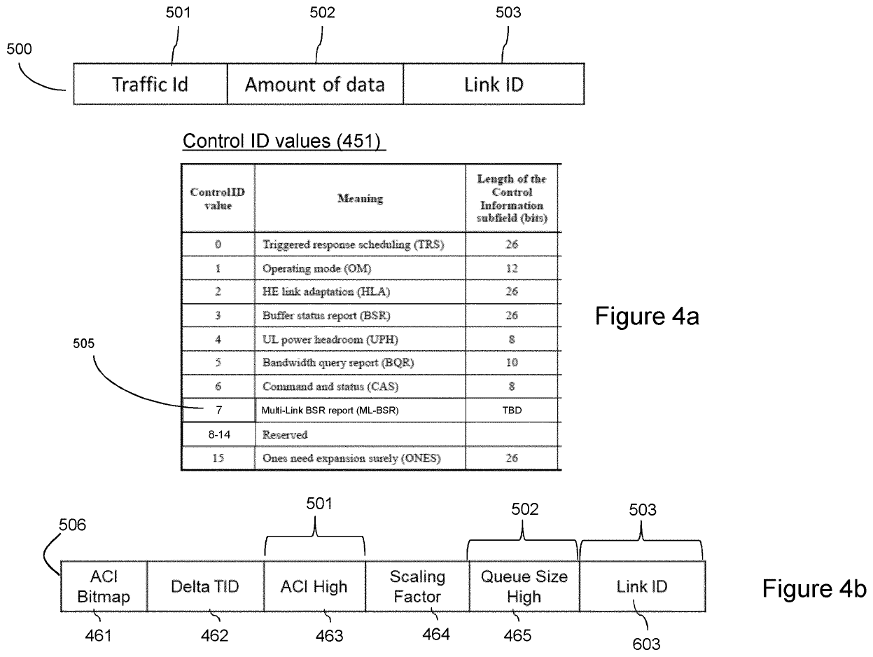

The FIGS. 4a and 4b described here below proposes to use a specific buffer status report adapted to multi-link devices, a multi-link buffer status report (ML-BSR), enabling each non-AP MLD to report for all traffics or for given traffic(s), the buffered amount of data awaiting to be transmitted together with a link, identified by the non-AP MLD, on which the non-AP MLD expects to be scheduled for transmitting the reported amount of data.

Receiving such ML-BSR, the AP MLD is then in possession of an additional information, regarding the link considered by the non-AP, as being the more adapted for a subsequent scheduling for an UL transmission, either in SU or MU mode.

A generic of a format of a multi-link buffer status report (ML-BSR) dedicated to multi-link devices is illustrated in FIG. 4a.

The proposed format 500 aims at being generic, in the sense it could be declined in a new independent format, as illustrated by FIG. 4a, or part of the format may be added to various existing types of reports, for example, in the 802.11ax buffer status as illustrated in FIG. 4b.

In some embodiments, at least a part of the report 500 is to be conveyed through the A-Control subfield 413 of the MAC header 410, as illustrated in FIG. 3. For instance, it may be indicated in Control Information subfield 452 when Control ID subfield 451 takes the value 7, values 8 up to 15 remaining reserved (see FIG. 4a).

The report 500 is referred hereinafter as Multi-Link Buffer Status report (ML-BSR). According to some embodiments, the usage of the ML-BSR is indicated through new entry 505 (e.g. Control ID having one value in between 7 to 14) in the Control ID table for A-Control fields.

As visible in FIG. 4a, the ML-BSR includes an indication relating to amount of data awaiting to be transmitted, associated with a link indication, on which the non-AP ML expects to transmit its data.

Thus, the ML-BSR 500 is composed of a Traffic Id subfield 501, an amount of data subfield 502, and a Link ID 503.

The first field 501 comprises an indication relating to the type of data for which the ML-BSR applies.

The type of data may be for example the traffic for which the ML-BSR is issued. Depending on the delivery service negotiated between the ML AP and the non-AP ML station generating the report, it may appear that the traffic indication may be of two forms: per-class report and per-flow report.

The traffic flows, having the same class, also share the same traffic queue. Thus, with per-class report, said traffic queue is considered in the report: the indication is then either an AC value indicative of an Access Category or a TID indicative of a Type of Traffic (i.e. User priority).

Besides, the format 500 comprises an indication relative to the amount of data awaiting to be transmitted by the non-AP MLD. The amount of data 502 corresponds to the count of buffered data units that are relevant for the present buffer reporting, i.e. data units relating to the considered traffic in the ML-BSR.

Additionally, the format 500 comprises an indication relating to the link on which the station expects to be scheduled by the AP MLD. The non-AP MLD, i.e. the affiliated stations, being aware of the disturbances occurring on the links, provides within the ML-BSR the indication of at least one link which is best adapted for the transmission of the amount of data awaiting to be transmitted. Further, when selecting the link, the non-AP MLD may further take into consideration the reported amount of data.

In the FIG. 4a, the Link ID subfield 503 indicates the link identifier of the reporting MLD to which the reported amount of data is related to. The Link ID subfield is set to 15 if the reported amount of data is global and no part has to be transmitted on a given Link, or if the reporting device does not have that information.

The Link ID is a current information for the AP, which helps simplicity and efficiency for scheduling next communication slots for the indicated Link. It shall be noted that the term “AP ID” could be used in place of “Link ID”.

Such a ML-BSR is therefore a mean for an originator non-AP MLD to help the scheduling AP MLD for ensuring that all awaiting data are delivered on time on the intended link.

The ML-BSR is a “live” information, or temporary information for subsequent scheduling. The ML-BSR is sent by the non-AP MLD using any of the enabled links between the non-AP MLD and the AP MLD, indifferently of the Link ID indicated in the report.

Receiving such a ML-BSR at the AP helps the AP MLD to manage traffics. Indeed, the ML-BSR is used by the non-AP MLD to inform the AP MLD of an instantaneous global transmission need over a given link for a given traffic, in the case of the use of per-class report format considering several flows.

Now, another example of ML-BSR is described in relation to FIG. 4b. The non-AP MLD can deliver ML-BSRs in the BSR Control subfield 460 of any frame transmitted to the AP, for example in response to a ML-BSRP Trigger frame.

An 802.11be/EHT station (AP and non-AP) may set a ML-BSR Support subfield in the EHT Capabilities element it transmits to 1; otherwise the station may set the ML-BSR Support subfield to 0. Thus, the ML-BSR Support subfield is therefore used by the non-AP MLD in order to indicate to the AP MLD, during the association procedure, whether the non-AP MLD supports ML-BSR.

FIG. 4b illustrates a ML-BSR 506 which is based on BSR Control field 460 of FIG. 3 according to 802.11ax.

The ML-BSR 506 comprises the fields described in relation to the BSR in the 802.11ax format: the ACI Bitmap field 461, the Delta TID field 462, the ACI High field 463, the Scaling Factor 464, the Queue size high 465.

Further to these known subfields, a Link ID field 603 is added.

The ML-BSR report format corresponds to the following fields: ACI High field 463, the Scaling Factor 464, the Queue size high 465 and the Link ID field 603.

The ACI High subfield indicates the ACI of the AC for which the ML-BSR is indicated in the Queue Size High subfield.

In other words, the ACI High subfield 463 indicates the ACI of the AC for which the ML-BSR is established. Thus, the ACI High indicates the AC for which the buffer status is reported in the Queue Size High 465, i.e. the amount of data awaiting to be sent for the indicated AC, corresponding to the field 502 of FIG. 4a.

Still, the Scaling Factor subfield indicates the unit SF, in octets, of the Queue Size High subfield.

The unit used for the reported amount of data is specified in the Scaling Factor subfield 464.

The Queue Size High subfield indicates the amount of buffered traffic, in units of SF octets, for the AC identified by the ACI High subfield that is intended for the STA identified by the receiver address of the frame containing the ML-BSR Control subfield, and that is intended to be delivered via the link specified by the Link ID subfield.

Therefore, the Queue Size High 465 subfield corresponds to the field 502 of FIG. 4a. The ML-BSR further comprises an indication relating the link on which the station expects to be scheduled for transmitting the buffered data specified in the Queue Size High 465. This indication is comprised in the Link ID field 603, indicating that the buffered data of the Queue Size High 465 is intended to be delivered via the link specified by the Link ID subfield.

The Link ID subfield 603 is 4-bits in length and indicates the link identifier that the reporting STA aims to transmit the specified amount of data traffic. The STA identified by the receiver address of the frame containing the ML-BSR Control subfield (e.g. AP MLD) is expected to schedule frames buffered at station emitting the ML-BSR for delivery on the link specified by this Link ID subfield 603.

The other subfields are not used for the ML-BSR report.

According to 802.11ax standard, the ACI Bitmap subfield 461 indicates the access categories for which the buffer status is reported, namely the Queue Size All 466.

According to some embodiments, the Queue Size All 466 may no longer be reported. Thus, the location of the Queue Size All subfield may be used for a Link ID subfield 603. A specific number of bits in the ACI Bitmap subfield 461 set to 0 may indicate that the report is a ML-BSR, such that the change of location is correctly interpreted.

As a result, receiving station will consider the buffer status 506 as a ML-BSR in the case where the ACI Bitmap subfield is 0 and the Delta TID subfield is different from 3 (because this value is already used in 802.11ax in this context of ACI Bitmap set to 0).

According to some embodiments, the Delta TID subfield is set to 0 as this value is not applicable for 802.11ax.

The context of the present invention described previously with reference to the FIGS. 1, 1a, 1b, 2, 3, 4a and 4b has highlighted that the new EML operations and the new TID-to-Link mapping mechanism currently specified in IEEE P802.11be/D2.0 may suffer from a lack of rules to efficiently coexist with each other.

In the EMLMR or EMLSR frame exchange operations initiated by the AP MLD as currently specified in IEEE P802.11be/D2.0, the choice of the EMLMR or EMLSR link used for the frame exchange sequence is driven by the AP MLD when sending the Initial frame or Initial Control frame. Currently, the standard doesn't specify any rule for the matching of this chosen EMLMR link or EMLSR link with the TID-To-Link mapping in use between the AP MLD and non-AP MLD. In some situations, especially for TB UL traffic, this lack of rules may lead to some mismatches and inefficiencies.

As a first illustration, under a negotiated uplink TID-To-Link mapping with TID-To-Link mapping Negotiation Supported subfield set to 1, in case of an Initial Frame or Initial Control Frame being a BSRP Trigger Frame sent by the AP MLD, the BSR response frame sent by a non-AP MLD may report buffered traffic for some TIDs not mapped on the link in which the BSRP TF was received. In such a case, the triggering of the non-AP MLD for an UL transmission by the AP MLD on this link is useless and the overall EML operation initiated is inefficient.

As a second illustration, under the Default TID-To-Link mapping or a negotiated uplink TID-To-Link mapping with TID-To-Link mapping Negotiation Supported subfield set to 2, in case of an Initial Frame or Initial Control Frame being a BSRP Trigger Frame sent by the AP MLD, the ML-BSR response frame sent by a non-AP MLD may indicate a link to transmit its buffered traffic that is not the link in which the BSRP TF was received. In such a case, the triggering of the non-AP MLD for an UL transmission by the AP MLD on this link may be unsuccessful as the non-AP MLD local conditions (i.e. interferences . . . ) are not taken into account. In such case, once again, the overall EML operation initiated is inefficient.

It is an object of the present invention to harmonize EML modes operations, be it EMLMR or EMLSR, with the Uplink TID-To-Link mapping for Trigger Based Uplink traffic transmission. Embodiments of the present invention aiming at achieving this goal are described hereafter with reference to the FIGS. 5a, 5b, 5c, 6, 7, 8, 9 and 10. These embodiments specify:
1. A new signaling allowing to operate, for TB UL traffic, either under the current specified EML operation or under a new EML operation, be it EMLSR or EMLMR operation.
2. New rules to match the UL TID-To-Link mapping with the current specified EML operation for TB UL traffic. The aim being to cover inefficiency of current EML operations, where BSR frame response could be useless without those rules.
3. New EML operation for TB UL traffic allowing EML link switching based on the content of BSR frame response.

In the present description, the two aforesaid “current EML operation for TB UL traffic” and “new EML operation for TB UL traffic” are also referred to as first and second submodes of the EML mode.

From the perspective of the non-AP MLD, the signaling information indicates which of the two following submodes of the EML mode is to be used:
a first submode of the EML mode, in which, in response to a BSRP trigger frame received from the AP MLD over a given EML link of the set of EML links, the non-AP MLD transmits to the AP MLD, over the given EML link, a BSR frame reporting buffered traffic as a function of the UL TID-To-Link mapping (e.g. buffered traffic, if any, of at least one UL TID that is mapped on the given EML link according to the UL TID-To-Link mapping); and
a second submode of the EML mode, in which, in response to a BSRP trigger frame received from the AP MLD over a first EML link, the non-AP MLD transmits to the AP MLD, over the first EML link, a BSR frame indicating a selected EML link among the set of EML links which is to be used for a frame exchange.

From the perspective of the AP MLD, the signaling information indicates which of the two following submodes of the EML mode is to be used:
a first submode of the EML mode including the transmission by the AP MLD of a Basic TF scheduling an UL resource to the non-AP MLD and containing a constraint, based on the UL TID-To-Link mapping, on the data to be transmitted within the scheduled UL resource; and
a second submode of the EML mode, in which the AP MLD retrieves from the BSR frame an indication of a selected EML link to be used for a frame exchange and transmits to the non-AP MLD, over the selected EML link, a Basic TF to trigger an uplink frame exchange with the non-AP MLD on the selected EML link.

FIG. 5a illustrates the EML Capabilities subfields in the Common Info field of a Basic Multi-Link Element as specified in the IEEE P802.11be/D2.0 standard and enriched with a new field according to embodiments of the invention.

During the ML setup procedure, the AP MLD and non-AP MLDs declare part or all of their capabilities. For instance, they may declare their EMLSR capability and/or EMLMR capability. As described below, appropriate fields are provided in the management frames, for instance in the ML Association Request/Response frames.

The management frames exchanged during the ML discovery and ML setup procedures contain new multi-link (ML) Information Elements specific to the Multi-Link Operation (MLO), referred to as Multi-Link elements. In particular, the ML Association Request/Response frames exchanged during the setup procedure are Association Request/Response frames as defined in 802.11ax (for example IEEE P802.11ax/D8.0 of October 2020) augmented with a Basic Multi-Link element defined in IEEE P802.11be/D2.0 in which the AP MLD and non-AP MLD can declare, amongst other declarations, their EML capabilities.

EML Capabilities subfield 520 is used to declare the MLD's capabilities in terms of enhanced multi-link, in particular regarding EMLSR and EMLMR. It includes an EMLSR Support subfield 521, an EMLSR Padding Delay subfield 522, an EMLSR Transition Delay subfield 523, an EMLMR Support subfield 524, an EMLMR Delay subfield 525, a Transition Timeout subfield 526 and a Reserved subfield 227.

More details on these subfields can be found in the IEEE P802.11be/D2.0 standard. On the FIG. 5a, the EML capabilities subfields 520 are enriched with a new subfield 528 according to the embodiments of the invention. This new subfield 528 is used by the AP MLD and non-AP MLDs to declare their support to the new EML operations described in the invention.

Link Indication for UL EML Frame Exchange Support subfield 528, preferably a one-bit subfield, is set to 1 if the MLD supports both the current EML operations and the new EML operations for Trigger Based Uplink EML frame exchange, i.e. supports both the EML frame exchange on the link in which a BSRP TF was transmitted/received and the EML frame exchange on the link indicated, either implicitly or explicitly, in the BSR frame for Trigger Based Uplink EML frame exchange, respectively.

Link Indication for UL EML Frame Exchange Support subfield 528, preferably a one-bit subfield, is set to 0 if the MLD supports only the current EML operations for Trigger Based Uplink EML frame exchange, i.e. supports only the EML frame exchange on the link in which a BSRP TF was transmitted/received for Trigger Based Uplink EML frame exchange.

FIG. 5b illustrates the format of the EML Control field of the EML OM Notification frame used to activate or deactivate an EML mode as defined in the IEEE P802.11be/D2.0 standard and enriched with a field according to embodiments of the invention.

The EML Control field 540 of the EML OM Notification frame includes a one-bit EMLSR Mode subfield 541, a one-bit EMLMR mode subfield 542, an EMLSR Link bitmap subfield 543, a reserved subfield 544, an EMLMR Link Bitmap subfield 545, a MCS Map count subfield 546 and an EMLMR supported MCS and NSS Set subfield 547.

A non-AP MLD supporting EMLSR operations (as declared in its EML capabilities) sets the EMLSR Mode subfield 541 to 1 to request an activation of the EMLSR mode and indicates the involved EMLSR links in the EMLSR Link Bitmap 543. This indicates that the non-AP MLD is going to operate in EMLSR mode. A non-AP MLD supporting EMLSR operations (as declared in its EML capabilities) sets the EMLSR Mode subfield 541 to 0 to indicate that it does no longer intend to operate in EMLSR mode.

Similarly, a non-AP MLD supporting EMLMR operations (as declared in its EML capabilities) sets the EMLMR Mode subfield 542 to 1 to request an activation of the EMLMR mode and indicates the involved EMLMR links in the EMLMR Link Bitmap 545. This indicates that the non-AP MLD is going to operate in EMLMR mode. A non-AP MLD supporting EMLMR operations (as declared in its EML capabilities) sets the EMLMR Mode subfield 542 to 0 to indicate that it does no longer intend to operate in EMLMR mode.

The D2.0 standard states that the two EMLSR and EMLMR modes are mutually exclusive.

More details on these subfields can be found in the IEEE P802.11be/D2.0 standard.

On the FIG. 5b, the EML Control field 540 is enriched with a new subfield 548 according to the embodiments of the invention. This new subfield 548 is used by the non-AP MLD to indicate to the AP MLD the EML operations mode to be used for the requested EMLSR or EMLMR activation. In such a case, the EML operation mode is driven by the non-AP MLD and all its Triggered Based Uplink EML frame exchanges with the AP MLD happening within this EMLSR or EMLMR activation will use this same EML operation mode.

Link Indication for UL EML Frame Exchange Mode subfield 548, preferably a one-bit subfield, is set to 1 to indicate the use of the new EML operations for Trigger Based Uplink EML frame exchange, i.e. to indicate to perform the EML frame exchange on the link indicated, either implicitly or explicitly, in the BSR frame for Trigger Based Uplink EML frame exchange.

Link Indication for UL EML Frame Exchange Mode subfield 548, preferably a one-bit subfield, is set to 0 to indicate the use of the current EML operations for Trigger Based Uplink EML frame exchange, i.e. to indicate to perform the EML frame exchange on the link in which a BSRP TF was transmitted/received for Trigger Based Uplink EML frame exchange.

FIG. 5c illustrates the format of a Trigger Frame as defined in the IEEE P802.11be/D2.0 standard and enriched with two possible variants of a new field according to embodiments of the invention.

It should be understood that these two possible variants constitute a first and a second variant to the embodiment described previously with reference to the FIG. 5b.

The Trigger Frame 560 is a BSRP Trigger Frame based on the Trigger Frame format as defined in IEEE 802.11ax (HE) with some modified fields as defined in IEEE 802.11be/D2.0 (EHT).

The Trigger Frame 560 includes a MAC header 561, a Common Info field 562, a User Info List field 563, a Padding field 564 and a FCS field 565.

The Common Info field 562 is typically an EHT variant Common Info field with a Trigger Type set to the value 4 corresponding to a BSRP Trigger Frame.

The User Info field 563 includes of one of several EHT variant User Info fields 566.

More details on these fields can be found in the IEEE Std 802.11ax™-2021 and the IEEE P802.11be/D2.0 standards.

In a first variant of the FIG. 5c, the Common Info field 562 is enriched with a new subfield 568a according to the embodiments of the invention. This new subfield 568a is used by the AP MLD to indicate to the addressed non-AP MLDs the EML operations mode to be used for the next Trigger Based Uplink EML frame exchange. In such a case, the EML operation mode is driven by the AP MLD for a next Triggered Based Uplink EML frame exchange for all the non-AP MLD addressed by the BSRP Trigger Frame 560, meaning that all non-AP MLDs will use the same EML operations mode.

Link Indication for UL EML Frame Exchange Mode subfield 568a is typically a one-bit subfield, using, as example, one of the EHT reserved bits 56-62 available in the EHT variant Common Info field 562 or, using, as another example, one bit in an added EHT Trigger Dependent Common Info subfield in the EHT Common Info field 562.

Link Indication for UL EML Frame Exchange Mode subfield 568a, preferably a one-bit subfield, is set to 1 to indicate the use of the new EML operations for the next Trigger Based Uplink EML frame exchange, i.e. to indicate to perform the next EML frame exchange on the link indicated, either implicitly or explicitly, in the BSR frame for the next Trigger Based Uplink EML frame exchange.

Link Indication for UL EML Frame Exchange Mode subfield 568a, preferably a one-bit subfield, is set to 0 to indicate the use of the current EML operations for the next Trigger Based Uplink EML frame exchange, i.e. to indicate to perform the next EML frame exchange on the link in which a BSRP TF was transmitted/received for the next Trigger Based Uplink EML frame exchange.

In a second variant of the FIG. 5c, the User info field 566 is enriched with a new subfield 568b according to the embodiments of the invention. This new subfield 568b is used by the AP MLD to indicate to a given addressed non-AP MLD the EML operations mode to be used for the next Trigger Based Uplink EML frame exchange. In such a case, the EML operation mode is driven by the AP MLD for a next Triggered Based Uplink EML frame exchange for a given non-AP MLD addressed by the BSRP Trigger Frame 560, independently of other non-AP MLDs addressed by the BSRP Trigger Frame 560, meaning that other non-AP MLDs may use the same or a different EML operations mode.

Link Indication for UL EML Frame Exchange Mode subfield 568b is typically a one-bit subfield, using, as example, one of the reserved bits 25 available in the EHT variant User Info field 566 or, using, as another example, one bit in an added EHT Trigger Dependent User Info subfield in the EHT User Info field 566.

Link Indication for UL EML Frame Exchange Mode subfield 568b, preferably a one-bit subfield, is set to 1 to indicate the use of the new EML operations for the next Trigger Based Uplink EML frame exchange, i.e. to indicate to perform the next EML frame exchange on the link indicated, either implicitly or explicitly, in the BSR frame for the next Trigger Based Uplink EML frame exchange.

Link Indication for UL EML Frame Exchange Mode subfield 568b, preferably a one-bit subfield, is set to 0 to indicate the use of the current EML operations for the next Trigger Based Uplink EML frame exchange, i.e. to indicate to perform the next EML frame exchange on the link in which a BSRP TF was transmitted/received for the next Trigger Based Uplink EML frame exchange.

With reference to the FIGS. 5a, 5b and 5b described previously, the names “Link Indication for UL EML Frame Exchange Support” and “Link Indication for UL EML Frame Exchange Mode” are introduced for the new signalling according to embodiments of the invention. These names are mainly for illustration purpose and other names may be contemplated.

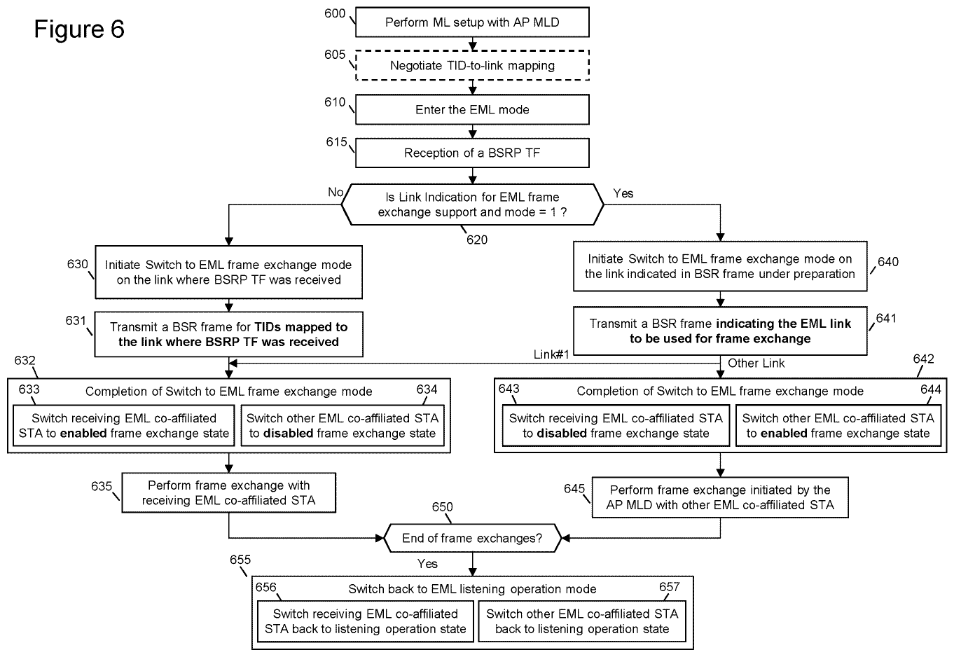

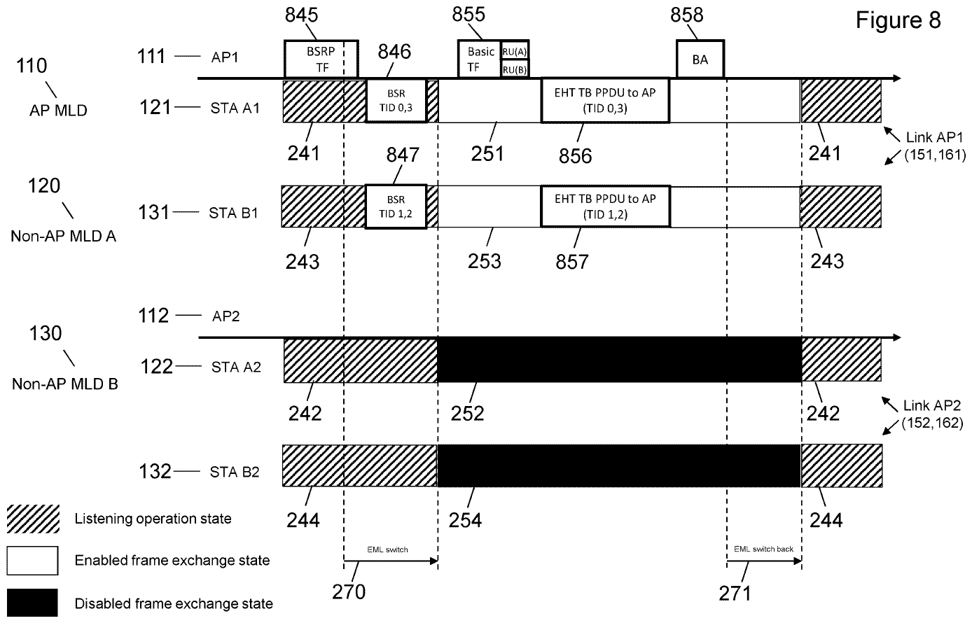

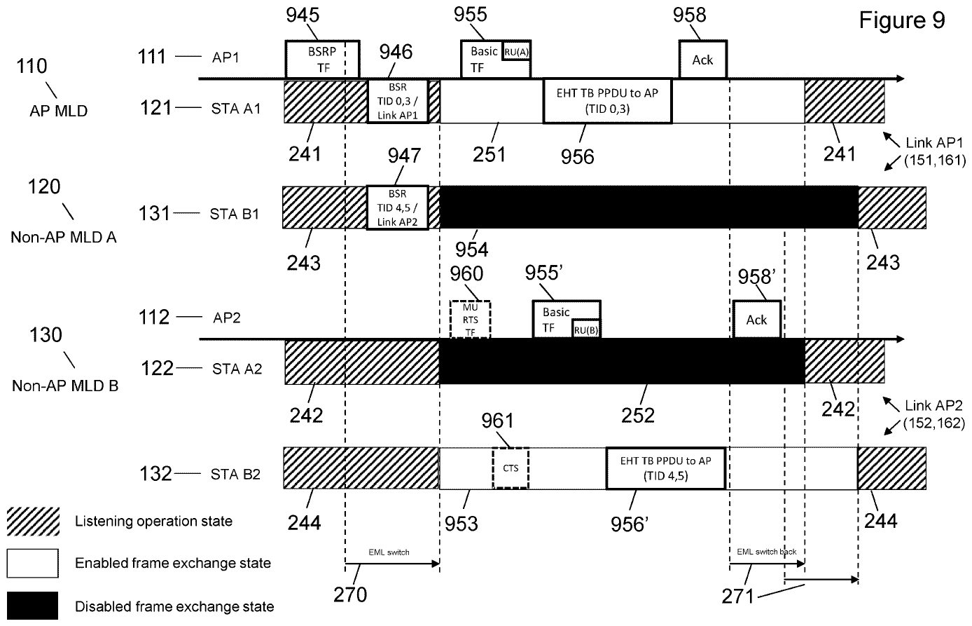

FIG. 6 illustrates, using a flowchart, steps performed by an EML-capable non-AP MLD to according to embodiments of the invention; this flowchart handles the sequences of frame exchange illustrated in the embodiments described in reference to the FIGS. 8 and 9 where the flowcharts steps are referenced.

At step 600 non-AP MLD performs ML Setup with the AP MLD. During this procedure, non-AP MLD and AP MLD notably exchange their EML Capabilities according to the invention where each MLD can indicate if it supports the new EML operation or not through the new subfield Link Indication for UL EML Frame Exchange Support (reference 528, FIG. 5a).

At step 605, optionally, non-AP MLD and AP MLD launch a TID-To-Link mapping procedure in order to negotiate a TID-To-Link mapping in DL, UL or both. This procedure can be launched during the ML setup or any time after the ML setup. As example, the non-AP MLD and AP MLD negotiate the TID-To-Link mapping described in the FIG. 8.

At step 610, the non-AP MLD enters in the EML mode (either EMLMR or EMLSR mode), typically by successfully exchanging, with the EML-capable AP MLD, an EML OM Notification with an EML Mode subfield (either EMLMR mode or EMLSR mode) of the EML Control field set to 1, which notification specifies also the EML links (either EMLMR links or EMLSR links), hence the corresponding EML co-affiliated STAs.

According to embodiments of the present invention, the non-AP MLD specifies the EML links under the rules 1 and 2 specified in the description of the FIG. 8.

In a particular embodiment, these rules can be summarized as follows: activating the EML mode includes, at the non-AP MLD, selecting a set of EML links in which links the EML mode is applied, as a function of the UL TID-To-Link mapping, and transmitting to an AP MLD a notification specifying the selected set of EML links. More details and variants are presented below in the description of FIG. 8.

As a new signaling, the non-AP MLD indicates also in the EML Control field 540 according to embodiments of the invention (see FIG. 5b) if the current EML mode operation or the new EML operation is to be used for the activated EML mode through the new subfield Link Indication for UL EML Frame Exchange Mode (reference 548, FIG. 5b).

In other words, the non-AP MLD transmits to the AP MLD a signaling information indicating which of the two aforesaid “current EML mode operation” and “new EML operation” (also referred to—see above—as first and second submodes of the EML mode) is to be used. In a particular embodiment, the signaling information is contained in a subfield (548) of the EML Control Field (540) of an EML OM Notification frame transmitted by the non-AP MLD.

The non-AP MLD is at that time in the EML listening operation mode, meaning its EML co-affiliated STAs are in the listening operation state, hence simultaneously listening to their respective link.

At step 615, an Initial Control frame or an Initial frame is received from the AP MLD by one of the EML co-affiliated STA on a receiving link.

Here, the received Initial Control frame or Initial frame is a BSRP Trigger Frame (TF) as described previously in FIG. 5c. The BSRP Trigger frame relates to Buffer Status Report Poll (BSRP) procedure introduced in IEEE Std 802.11ax™-2021 in order to solicit the uplink data requirements of solicited STAS (in particular by requesting their buffered uplink data amounts) and allow the AP to schedule resource allocation for synchronized uplink transmissions. In response to the BSRP trigger frame, each solicited/intended STA can send an immediate feedback Buffer Status Report (BSR), which may thus be considered as an Initial Control frame response or Initial frame response.

The received BSRP TF typically schedules the non-AP MLD and other non-AP MLD, or more generally explicitly triggers one or more recipient STAs.

As a first variant of the new signaling, the AP MLD indicates in the Common Info field 562 of the BSRP TF according to a particular embodiment of the invention (and more precisely in the new subfield “Link Indication for UL EML Frame Exchange Mode” referenced 568a in FIG. 5c) if the current EML operation mode or the new EML operation mode is to be used for the next upcoming UL EML frame exchange for all scheduled non-AP MLDs through the new subfield Link Indication for UL EML Frame Exchange Mode.

As a second variant of the new signaling, the AP MLD indicates in the non-AP MLD's User Info field 566 of the BSRP TF according to a particular embodiment of the invention (and more precisely in the new subfield “Link Indication for UL EML Frame Exchange Mode” referenced 568b in FIG. 5c) if the current EML operation mode or the new EML operation mode is to be used for the next upcoming UL EML frame exchange for the scheduled non-AP MLD through the new subfield Link Indication for UL EML Frame Exchange Mode.

In other words, in the first variant of the new signaling, the signaling information is contained in a subfield (568a) of a Common Info Field (562) and in the second variant of the new signaling it is in a subfield (568b) of a User Info field (566) assigned to the non-AP MLD, within the BSRP TF transmitted by the AP MLD.

At step 620 the non-AP MLD checks if the new EML operation mode is to be used by testing if both new subfields Link Indication for UL EML Frame Exchange Support and Link Indication for UL EML Frame Exchange Mode are set to 1.

In the negative of test 620, the next step is 630, meaning that the current EML operation with the new rules specified in embodiments of the present invention will be used.

In the positive of test 620, the next step is 640, meaning that the new EML operation specified in embodiments of the present invention will be used.

At step 630, the non-AP MLD initiates the switch of its EML co-affiliated STAs from the listening operation state to the EML frame exchange states. More precisely, it initiates the switch of its receiving EML co-affiliated STA from the Listening operation state to the Enabled frame exchange state on the link in which the BSRP TF was received. In parallel (simultaneously), it initiates the switch of its other EML co-affiliated STA from the Listening operation state to the Disabled frame exchange state on the other link.

At step 631, the receiving EML co-affiliated STA of the scheduled non-AP MLD transmits an initial Control frame response or Initial frame response which is a BSR frame.

According to a particular embodiment of the present invention, the non-AP MLD transmits the BSR frame under the rule 4 specified in the description of the FIG. 8.

In a particular embodiment, this rule can be summarized as follows: while the non-AP MLD operates in an EML mode with a set of EML links, it transmits, in response to a Buffer Status Report Poll, BSRP, trigger frame received from the AP MLD over a first EML link of the set of EML links, a BSR frame reporting buffered traffic as a function of the UL TID-To-Link mapping, to the AP MLD, over the first EML link. More details and variants are presented below in the description of FIG. 8.

Next, at step 632, the non-AP MLD completes the switch if its EML co-affiliated STAs from the EML listening operation state to the EML frame exchange states. More precisely, it completes, at step 633, the switch of its receiving EML co-affiliated STA from the Listening operation state to the Enabled frame exchange state on the link in which the BSRP TF was received. In parallel (simultaneously), at step 634, it initiates the switch of its other EML co-affiliated STA from the Listening operation state to the Disabled frame exchange state on the other link.

Next at step 635, the receiving EML co-affiliated STA of non-AP MLD performs the frame exchange sequence with the corresponding affiliated AP of AP MLD over the receiving link, i.e. the link in which the BSRP TF was received.

At step 640, the non-AP MLD initiates the switch of its EML co-affiliated STAs from the listening operation state to the EML frame exchange states based on the content of the BSR frame under preparation.

More precisely, if the BSR frame under preparation indicates, either implicitly or explicitly, that the link to be used for frame exchange is the receiving link (i.e. the link in which the BSRP TF was received), it initiates the switch of its receiving EML co-affiliated STA from the Listening operation state to the Enabled frame exchange state on the link in which the BSRP TF was received. In parallel (simultaneously), it initiates the switch of its other EML co-affiliated STA from the Listening operation state to the Disabled frame exchange state on the other link.

If the BSR frame under preparation indicates, either implicitly or explicitly, that the link to be used for frame exchange is the other link, it initiates the switch of its other EML co-affiliated STA from the Listening operation state to the Enabled frame exchange state on the other link. In parallel (simultaneously), it initiates the switch of its receiving EML co-affiliated STA from the Listening operation state to the Disabled frame exchange state on the receiving link.

According to a particular embodiment of the present invention, the non-AP MLD identifies the link to be used for EML frame exchange based on the content of the BSR frame under preparation based on the rules 6, 8 and 9 specified in the description of the FIG. 9.

In a particular embodiment, these rules can be summarized by the fact the non-AP MLD carries out the following actions:
receiving a BSRP TF from an AP MLD over a first EML link of the set of EML links; selecting among the set of EML links an EML link to be used for a frame exchange, as a function of the UL TID-To-Link mapping and of a buffered traffic to be reported in a BSR frame; and
transmitting to the AP MLD, over the first EML link, the BSR frame indicating the selected EML link, which is to be used for the frame exchange. More details and variants are presented below in the description of FIG. 9.

At step 641, the receiving EML co-affiliated STA of the scheduled non-AP MLD transmits an initial Control frame response or Initial frame response which is a BSR frame.

If the transmitted BSR frame indicates, either implicitly or explicitly, that the link to be used for frame exchange is the receiving link (i.e. the link in which the BSRP TF was received, Link #1), the next step is step 632 already described.

If the transmitted BSR frame indicates, either implicitly or explicitly, that the link to be used for frame exchange is the other link, the next step is step 642.

Next, at step 642, the non-AP MLD completes the switch if its EML co-affiliated STAs from the EML listening operation state to the EML frame exchange states. More precisely, it completes, at step 643, the switch of its other EML co-affiliated STA from the Listening operation state to the Enabled frame exchange state on the other link. In parallel (simultaneously), at step 644, it initiates the switch of its receiving EML co-affiliated STA from the Listening operation state to the Disabled frame exchange state on the receiving link (i.e. the link in which the BSRP TF was received, Link #1).

Next at step 645, the other EML co-affiliated STA of non-AP MLD performs the frame exchange sequence with the corresponding affiliated AP of AP MLD over the other link.

The frame exchanges of either steps 635 or 645 continue as long as no end of frame exchanges is detected at step 650 over the link used for frame exchange (either the receiving link for frame exchange 635 and the other link for frame exchange 645).

When such end of frame exchanges is detected at test 650, the non-AP MLD switches back to the EML listening operation state at step 655. For this, the receiving EML co-affiliated STA corresponding to the receiving link is switched back to the listening operation state at step 656, while in parallel (synchronously), the other EML co-affiliated STA is also switched back to the listening operation state at step 657.

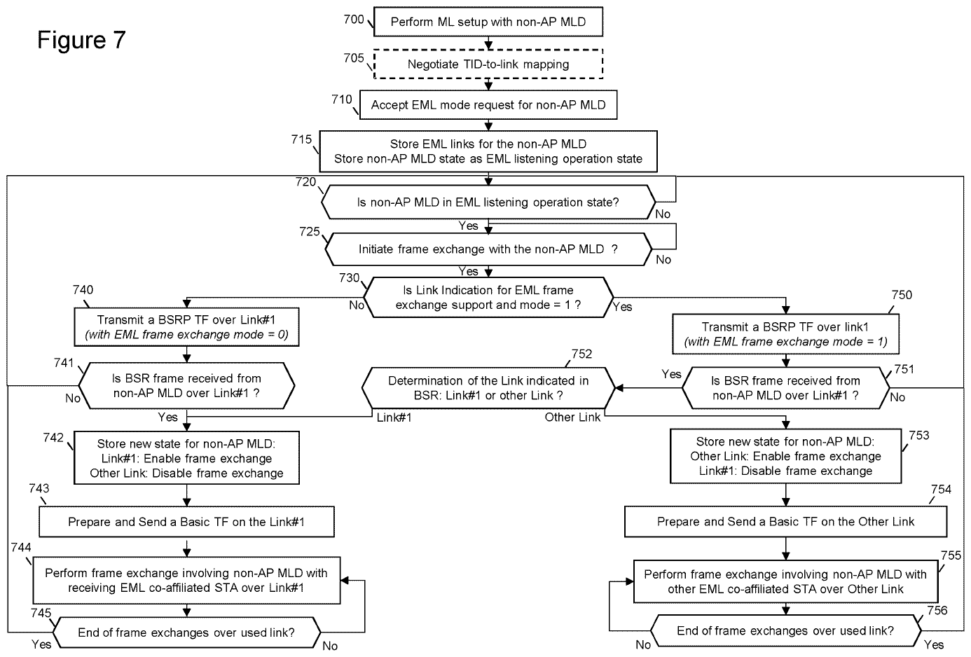

FIG. 7 illustrates, using a flowchart, corresponding steps performed by the EML-capable AP MLD according to some embodiments of the invention; this flowchart handles the sequences of frame exchange illustrated in the embodiments described in reference to the FIGS. 8 and 9 where the flowcharts steps are referenced.

In this flowchart, the exemplary steps performed by the AP MLD are processed with respect to a given non-AP MLD, meaning that the same process is performed with respect to each non-AP MLD entering an EML mode.

At step 700, the AP MLD performs ML Setup with the non-AP MLD. During this procedure, AP MLD and non-AP MLD notably exchange their EML Capabilities according to embodiments of the invention where each MLD can indicate if it supports the new EML operation or not through the new subfield Link Indication for UL EML Frame Exchange Support.

At step 705, optionally, AP MLD and non-AP MLD launch a TID-To-Link mapping procedure in order to negotiate a TID-To-Link mapping in DL, UL or both. This procedure can be launched during the ML setup or any time after the ML setup. As example, the AP MLD and non-AP MLD negotiate the TID-To-Link mapping described in the FIG. 8.

The step 710 corresponds to the successful exchange of EML OM Notifications with the non-AP MLD for the latter to enter the EML mode. As mentioned above, the EML OM Notification received from the non-AP MLD specifies the EML links, hence the corresponding EML co-affiliated STAs.

As a new signaling according to a particular embodiment of the invention, the EML Control field 540 of the EML OM Notification received from the non-AP MLD indicates if the current EML mode operation or the new EML operation is to be used for the activated EML mode through the new subfield Link Indication for UL EML Frame Exchange Mode (reference 548, FIG. 5b). Next, at step 715, the AP MLD stores, among several other parameters, the EML links in local memory and stores the non-AP MLD state as being the EML listening operation state. For example, the AP MLD may store in local memory a first indication that a first link of the EML links is in the listening operation state and a second indication that a second link of the EML links is in the listening operation state too.

Next, at the step 720, the AP MLD checks whether the non-AP MLD is in the EML listening operation mode.

In the negative, the process loops back to step 720.

In the affirmative, the process goes to step 725.

At the step 725, the AP MLD checks whether there is a need to initiate a frame exchange sequence with one or more non-AP MLDs. Various criteria may be used for each non-AP MLD. For example, the AP MLD may have data in local buffer to send to the non-AP MLD. As another example, the AP MLD may be aware that the non-AP MLD needs uplink resources. As yet another example, the AP MLD may poll the non-AP MLD to know its Buffer Status Reports (BSR).

In the negative, the process loops back to step 725.

In the affirmative, the AP MLD starts to build the content of the Initial Control frame or Initial frame, being here a BSRP TF, and the process goes to the step 730.

As a first variant of the new signaling, the AP MLD builds the BSRP TF by indicating in the Common Info field 562 according to a particular embodiment of the invention if the current EML operation mode or the new EML operation mode is to be used for the next upcoming UL EML frame exchange for all scheduled non-AP MLDs through the new subfield Link Indication for UL EML Frame Exchange Mode (reference 568a, FIG. 5c).

As a second variant of the new signaling, the AP MLD builds the BSRP TF by indicating in the non-AP MLD's User Info field 566 according to a particular embodiment of the invention if the current EML operation mode or the new EML operation mode is to be used for the next upcoming UL EML frame exchange for the scheduled non-AP MLD through the new subfield Link Indication for UL EML Frame Exchange Mode (reference 568b, FIG. 5c).

Then, at step 730 the AP MLD checks if the new EML operation mode is to be used by testing if both new subfields Link Indication for UL EML Frame Exchange Support and Link Indication for UL EML Frame Exchange Mode are set to 1.

In the negative of test 730, the next step is 740, meaning that the current EML operation with the new rules specified in embodiments of the present invention will be used.

In the positive of test 730, the next step is 750, meaning that the new EML operation specified in embodiments of the present invention will be used.

At the step 740, the AP MLD transmits a BSRP TF scheduling one or more non-AP MLDs over one shared link of their EML links, referred to as Link #1 for simplicity.

As mentioned above, in the first or second variant of the new signaling, the AP MLD transmits the BSRP TF by setting the new subfield Link Indication for UL EML Frame Exchange Mode to 0, i.e. indicating that the current EML operation mode will be used.

According to a particular embodiment of the present invention, the AP MLD prepares and transmits the BSRP TF frame under the rule 3 specified in the description of the FIG. 8.

At step 741, the AP MLD checks whether a BSR frame is received in due time from the non-AP MLD or MLDs over the Link #1.

In the negative, the process loops back to step 720.

In the affirmative, the AP MLD takes into account that the non-AP MLD has completed its switch to the EML frame exchange states. Therefore, at step 742, the AP MLD stores in local memory such states for each of the scheduled non-AP MLD. For example, the AP MLD may set the first indication for link #1 as being the enabled frame exchange state and a second indication for the other EML link as being the disabled frame exchange state.

In the step 743, the AP MLD prepares and sends a Basic TF triggering the non-AP MLDs for an MU UL OFDMA transmission on Link #1.

According to a particular embodiment of the present invention, the AP MLD prepares and transmits the Basic TF frame under the rule 5 specified in the description of the FIG. 8.

In a particular embodiment, this rule can be summarized by the fact the AP MLD carries out the following actions:
transmitting to the non-AP MLD, over a first EML link of a set of EML links, a BSRP TF;
receiving from the non-AP MLD, over the first EML link, a BSR frame reporting buffered traffic; and
transmitting to the non-AP MLD, over the first EML link, a Basic TF scheduling an UL resource to the non-AP MLD and containing a constraint, based on the UL TID-To-Link mapping, on the data to be transmitted within the scheduled UL resource.

More details and variants are presented below in the description of FIG. 8.

Next at step 744, the receiving EML co-affiliated STA of non-AP MLD and the corresponding affiliated AP of AP MLD perform the frame exchange sequence over the link #1 (i.e. the receiving link, i.e. the link in which the BSRP frame was transmitted).

At the step 750, the AP MLD transmits a BSRP TF scheduling one or more non-AP MLDs over one shared link of their EML links, referred to as Link #1 for simplicity.

As mentioned above, in the first or second variant of the new signaling, the AP MLD transmits the BSRP TF by setting the new subfield Link Indication for UL EML Frame Exchange Mode to 1, i.e. indicating that the new EML operation mode will be used.

At step 751, the AP MLD checks whether a BSR frame is received in due time from the non-AP MLD or MLDs over the Link #1.

In the negative, the process loops back to step 720.

In the affirmative, the process goes to step 752.

At the step 752, the AP MLD decodes the BSR frame and determines the link to be used for the next EML frame exchange with the non-AP MLD.

More precisely, if the received BSR frame indicates, either implicitly or explicitly, that the link to be used for frame exchange is the receiving link (i.e. the link in which the BSRP TF was received, i.e. Link #1), the process goes to the step 742 already described.

If the received BSR frame indicates, either implicitly or explicitly, that the link to be used for frame exchange is the other link, the process goes to the step 753.

According to a particular embodiment of the present invention, the AP MLD identifies the link to be used for EML frame exchange based on the content of the received BSR frame under the rules 7, 8 and 9 specified in the description of the FIG. 9.

In a particular embodiment, these rules can be summarized by the fact the AP MLD carries out the following actions:
receiving from the non-AP MLD, over a first EML link of the set of EML links, a BSR frame in response to a BSRP TF, transmitted over the first EML link;
retrieving from the BSR frame, an indication of a selected EML link among the EML links, which is to be used for a frame exchange; and
transmitting to the non-AP MLD, over the selected EML link, a Basic TF to trigger an uplink frame exchange with the non-AP MLD on the selected EML link.

More details and variants are presented below in the description of FIG. 9.

At the step 753, the AP MLD takes into account that the non-AP MLD has completed its switch to the EML frame exchange states. Therefore, at step 753, the AP MLD stores in local memory such states for each of the scheduled non-AP MLD. For example, the AP MLD may set the first indication for Other Link as being the enabled frame exchange state and a second indication for the Link #1 as being the disabled frame exchange state.

In the step 754, the AP MLD prepares and sends a Basic TF triggering the non-AP MLDs for an MU UL OFDMA transmission on Other Link.

According to a particular embodiment of the present invention, the AP MLD prepares and transmits the Basic TF frame under the rule 5 specified in the description of the FIG. 8.

Next at step 755, the other EML co-affiliated STA of non-AP MLD and the corresponding affiliated AP of AP MLD perform the frame exchange sequence over the Other Link.

The frame exchanges of either steps 744 or 755 continue as long as no end of frame exchanges is detected at steps 745 or 756, respectively, over the respective link used for frame exchange (either the receiving link (Link #1) for frame exchange 745 or the other link for frame exchange 755).

When the end of frame exchange is detected at step 745 or 756, the process loops back to step 720.

FIG. 8 schematically illustrates a first possible operation handled in the flowcharts of FIGS. 6 and 7 using an exemplary sequence of frame exchange between the EML-capable AP MLD and EML-capable non-AP MLDs.

In this FIG. 8, the initial Control frame or Initial frame is a BSRP Trigger frame and the Initial Control frame response or Initial frame response is a BSR frame in a context of a MU UL OFDMA transmission.

The same references as FIG. 2 correspond to the same frame/state or the like.

Again, the AP MLD 110 includes the two affiliated AP 111 and 112, the non-AP MLD 120 includes the two affiliated STA 121 and 122 and the non-AP MLD 130 includes the two affiliated STA 131 and 132.

In this FIG. 8, it is assumed that the two affiliated STA 121 and 122 of non-AP MLD 120 and the two affiliated STA 131 and 132 of non-AP MLD 130 are able to send a BSR frame while being in the Listening operation state.

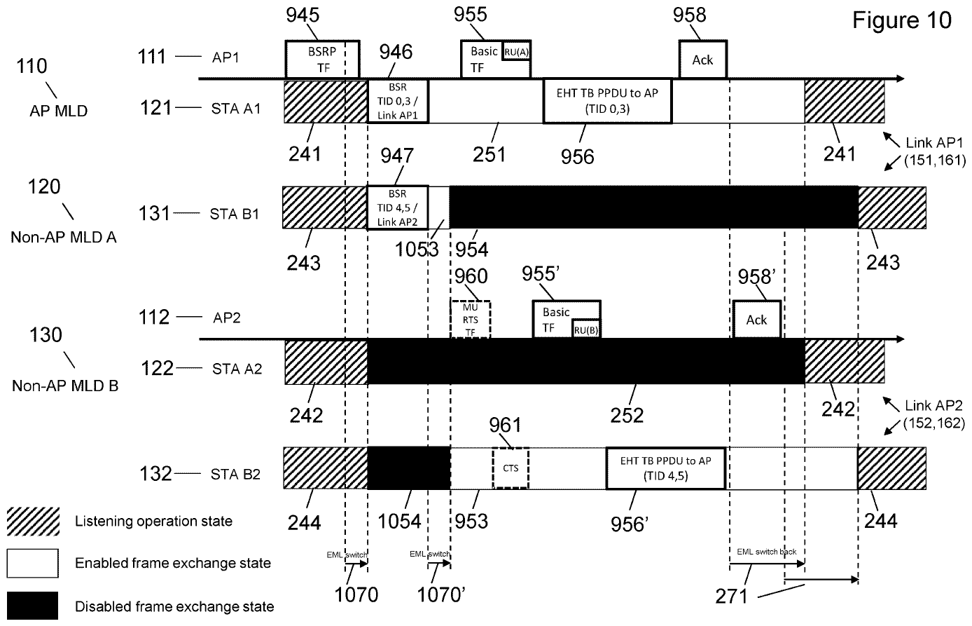

In the embodiment of this FIG. 8, and also in the next embodiments that will be described with reference to the FIGS. 9 and 10, unless clearly indicated, it is considered that the TID-To-Link mapping shown in the table below has been negotiated (steps 605,705), firstly, between AP MLD 110 and non-AP MLD 120 and, secondly, between AP MLD 110 and non-AP MLD 130:

| | TID-To-Link mapping | DL TID-To-Link | | UL TID-To-Link | |
|---|---|---|---|---|---|
| | negotiation type | mapping | | Mapping | |
| | DL/UL | Link AP1 | Link AP2 | Link AP1 | Link AP2 |
| Non-AP MLD 120 | 2/1 | All TIDs | All TIDs | TIDs 0, 3, 1, 2 | TIDs 4, 5, 6, 7 |
| Non-AP MLD 130 | 2/1 | All TIDs | All TIDs | TIDs 0, 3, 1, 2 | TIDs 4, 5, 6, 7 |

To summarize, the same Downlink TID-To-Link mapping has been negotiated between the AP MLD 110 and non-AP MLD 120 and between AP MLD 110 and non-AP MLD 130. Under this DL negotiated TID-To-Link mapping, all TIDs are mapped to the links set [Link AP1, Link AP2].

The same Uplink TID-To-Link mapping has been negotiated between the AP MLD 110 and non-AP MLD 120 and between AP MLD 110 and non-AP MLD 130. Under this negotiated UL TID-To-Link mapping, TIDs 0,3 and 1,2 are mapped to the Link AP1 and TIDs 4,5 and 6,7 are mapped to the Link AP2.

In the FIG. 8, both non-AP MLDs 120 and 130 are EML active (i.e. either EMLSR active or EMLMR active) with the EML links (i.e. either EMLSR links or EMLMR links) corresponding to EML co-affiliated STAs 121 and 122 for non-AP MLD 120 and the EML links (i.e. either EMLSR links or EMLMR links) corresponding to EML co-affiliated STAs 131 and 132 for non-AP MLD 130. The non-AP MLDs 120 and 130 have activated the EML mode and indicated the EML links by sending an EML OM Notification frame to the AP MLD 110 (steps 610,710).

Regarding the EML links involved in the activated EML mode, both non-AP MLDs 120 and 130 have applied the following rules specified by a particular embodiment of the present invention:

Rule 1: (non-AP MLD) Under a negotiated UL TID-To-Link mapping with a TID-To-Link Mapping Negotiation Supported subfield value=1, at least one link of the EML links indicated in the EML Link Bitmap shall have at least one UL TID mapped.

Rule 2: (non-AP MLD) Under a negotiated UL TID-To-Link mapping with a TID-To-Link Mapping Negotiation Supported subfield value=2, the set of EML links indicated in the EML Link Bitmap shall not be disjoint from the link set on which all UL TIDs are mapped.

A variant (second formulation) of rule 1 reads as follows: “selecting the set of EML links as a function of the UL TID-To-Link mapping comprises fulfilling a constraint that at least one EML link of the set of EML links shall have at least one UL TID mapped according to the UL TID-To-Link mapping”. According to this variant, the constraint (that at least one EML link of the set of EML links shall have at least one UL TID mapped) applies whatever the UL TID-To-Link mapping. The first formulation (case where the UL TID-To-Link mapping is a negotiated UL TID-To-Link mapping with a TID-To-Link Mapping Negotiation Supported subfield value equal to 1) of rule 1 is therefore a particular case of this variant.

A variant (second formulation) of rule 2 reads as follows: “selecting the set of EML links as a function of the UL TID-To-Link mapping comprises fulfilling a constraint that the set of EML links shall not be disjoint from another set of links on each of which all UL TIDs are mapped according to the UL TID-To-Link mapping”. According to this variant, the constraint (that the set of EML links shall not be disjoint from said other set of links) applies whatever the UL TID-To-Link mapping. The first formulation (case where the UL TID-To-Link mapping is a negotiated UL TID-To-Link mapping with a TID-To-Link Mapping Negotiation Supported subfield value equal to 1) of rule 2 is therefore a particular case of this variant.

In this FIG. 8, it is considered that AP MLD 110, non-AP MLD 120 and non-AP MLD 130 operate under the “current EML operations”, with the new rules specified above (steps 630-635, 740-745). This means that some MLDs have either set the Link Indication for UL EML Frame Exchange Support subfield to 0 during the ML setup (steps 600,700), or set the Link Indication for UL EML Frame Exchange Mode subfield to 0 when activating the EML mode (step 610) or when Initiating the UL EML frame exchange (step 740).

At the beginning of the sequence, both non-AP MLDs 120 and 130 are in the EML listening operation state, meaning that the EML co-affiliated STAs 121 and 122 of non-AP MLD 120 are both in the listening operation state 241 and 242, as well the EML co-affiliated STAs 131 and 132 of non-AP MLD 130 are both in the listening operation state 243 and 244.

When the AP MLD 110 desires to initiate a frame exchange sequence with non-AP MLDs A 120 and B 130 to know their BSRs, it transmits through its affiliated AP AP1 111 a BSRP Trigger frame 845 (step 740) as Initial Control frame or Initial frame which is received by the EML co-affiliated STA A1 121 of the non-AP MLD 120 and the EML co-affiliated STA B1 131 of the non-AP MLD 130. The BSRP Trigger frame 845 schedules both non-AP MLD A 120 and non-AP MLD B 130.

Regarding the transmitted BSRP frames 845, AP MLD 110 has applied the following rule specified by a particular embodiment of the present invention:

Rule 3: (AP MLD) Under a negotiated UL TID-To-Link mapping with a TID-To-Link Mapping Negotiation Supported subfield value=1, the BSRP TF should be transmitted on an EML link on which at least one UL TID is mapped.

A variant (second formulation) of rule 3 reads as follows: “transmitting to the non-AP MLD, over a first enabled link (e.g. a first EML link) on which at least one UL TID is mapped according to the UL TID-To-Link mapping, a Buffer Status Report Poll, BSRP, trigger frame, TF”. This variant applies whatever the UL TID-To-Link mapping. The first formulation (case where the UL TID-To-Link mapping is a negotiated UL TID-To-Link mapping with a TID-To-Link Mapping Negotiation Supported subfield value equal to 1) of rule 3 is therefore a particular case of this variant.

In both non-AP MLD 120 and 130, the reception of the BSRP Trigger frame 845 initiates the EML switch 270 (step 630), corresponding either to the EMLSR active switch delay or to the EMLMR active switch delay as described previously. Operating under the current EML operations, both non-AP MLD 120 and 130 initiates the switch of their receiving EML co-affiliated STA A1 121 and STA B1 131, respectively, to the enabled frame exchange state on the link in which the BSRP TF was received; in parallel (synchronously), both non-AP MLD 120 and 130 initiates the switch of their other EML co-affiliated STA A2 122 and STA B2 132, respectively, to the disabled frame exchange state on the other link.

In the meantime, in response to the BSRP TF 845, receiving EML co-affiliated STA A1 121 of scheduled non-AP MLD A 120 transmits a BSR 846 (step 631) indicating the amount of buffered uplink data of the scheduled non-AP MLD A 120 and receiving EML co-affiliated STA B1 131 of scheduled non-AP MLD B 130 transmits a BSR 847 indicating the amount of buffered uplink data of the scheduled non-AP MLD B 130.

Regarding the transmitted BSR frames 846 and 847, both non-AP MLDs 120 and 130 have applied the following rule specified by a particular embodiment of the present invention:

Rule 4: (non-AP MLD) Under a negotiated UL TID-To-Link mapping with a TID-To-Link Mapping Negotiation Supported subfield value=1, the response to a BSRP TF shall report buffered traffic, if any, of at least one TID that is mapped on the EML link in which the BSRP TF was received.

A variant (second formulation) of rule 4 reads as follows: “the BSR frame reports buffered traffic, if any, of at least one UL TID that is mapped on the first EML link according to the UL TID-To-Link mapping”. This variant applies whatever the UL TID-To-Link mapping. The first formulation (case where the UL TID-To-Link mapping is a negotiated UL TID-To-Link mapping with a TID-To-Link Mapping Negotiation Supported subfield value equal to 1) of rule 4 is therefore a particular case of this variant.

Another variant (third formulation) of rule 4 reads as follows: “the BSR frame reports buffered traffic, if any, only of UL TID(s) that is (are) mapped on the first EML link according to the UL TID-To-Link mapping”. This other variant applies whatever the UL TID-To-Link mapping. However, in a particular implementation of this other variant, a condition of application is that the UL TID-To-Link mapping is a negotiated UL TID-To-Link mapping with a TID-To-Link Mapping Negotiation Supported subfield value equal to 1.

According to this rule, the BSR 846, transmitted by the non-AP MLD 120 on the link AP1 in which the BSRP TF 845 was received, indicates the amount of buffered uplink data for TIDS 0,3. According to this rule, similarly, the BSR 847, transmitted by the non-AP MLD 130 on the link AP1 in which the BSRP TF 845 was received, indicates the amount of buffered uplink data for TIDs 1,2.

With reference to the FIG. 3 described previously, as example, the BSRs 846 and 847 may use the 802.11ax BSR format 460:
For the BSR 846, the ACI Bitmap subfield 461 set to the value “0100” to indicate buffer data for AC1, the Delta TID subfield 462 is set to the value “01” to indicate buffered data for 2 TIDs and the Queue Size All subfield 466 is set to a value corresponding to the total amount of buffered data for these 2 TIDs, i.e. TIDs 0,3.
For the BSR 847, the ACI Bitmap subfield 461 set to the value “1000” to indicate buffer data for AC0, the Delta TID subfield 462 is set to the value “01” to indicate buffered data for 2 TIDs and the Queue Size All subfield 466 is set to a value corresponding to the total amount of buffered data for these 2 TIDs, i.e. TIDs 1,2.

After the EML switch delay 270, both scheduled non-AP MLD 120 and non-AP MLD 130 have completed their switch from the EML listening operation mode to EML frame exchange mode (step 632), meaning the receiving EML co-affiliated STAs A1 121 and B1 131 have switched respectively from the listening operation state 241, 243 to the enabled frame exchange state 251, 253 on Link AP1 (step 633), while the other EML co-affiliated STAs A2 122 and B2 132 have switched respectively from the listening operation state 242, 244 to the disabled frame exchange state 252, 254 on Link AP2 (634).

Frame 855 can then be exchanged within the initiated frame exchange sequence (step 635, 743-744), i.e. over Link AP1 (Link #1) with affiliated AP AP1 111. Various types of frames 855 can be used, e.g. a downlink HE MU PPDU or a Basic TF frame to trigger MU UL OFDMA communication.

Regarding the Basic trigger frame 855, AP MLD 110 has applied the following rule specified by a particular embodiment of the present invention:

Rule 5: (AP MLD) Under a negotiated UL TID-To-Link mapping with a TID-To-Link Mapping Negotiation Supported subfield value=1, the Basic TF should indicate, in the Preferred AC subfield of its Trigger Dependent User Info subfield, the value for an AC corresponding to UL TIDs that are mapped on the link in which the Basic TF is transmitted/received.

A variant (second formulation) of rule 5 reads as follows: “a Basic TF scheduling an UL resource to the non-AP MLD and containing a constraint, based on the UL TID-To-Link mapping, on the data to be transmitted within the scheduled UL resource”. This variant applies whatever the UL TID-To-Link mapping. The first formulation (case where the UL TID-To-Link mapping is a negotiated UL TID-To-Link mapping with a TID-To-Link Mapping Negotiation Supported subfield value equal to 1) of rule 5 is therefore a particular case of this variant.

In a particular implementation of this variant, the constraint on the data to be transmitted within the scheduled UL resource is indicated by a value of an Access Category, AC, corresponding to UL TIDs that are mapped on the first enabled link (e.g. a first EML link) according to the UL TID-To-Link mapping. Preferentially, the value is indicated in a preferred AC subfield of a Trigger Dependent User Info field of a User Info field corresponding to the scheduled UL resource within the Basic TF. Also preferentially, the constraint on the data to be transmitted by the non-AP MLD applies if the UL TID-To-Link mapping is a negotiated UL TID-To-Link mapping with a TID-To-Link Mapping Negotiation Supported subfield value equal to 1.

The AP MLD 110 through the affiliated AP 111 transmits a Basic TF 855 containing RUs allocation information indicating that resource units are assigned for scheduled non-AP MLD A 120 and non-AP MLD B 130:
the non-AP MLD A 120 is therefore scheduled (more generally explicitly triggered) by frame 855 and can then perform the UL EML frame exchange by providing a response, here an EHT TB PPDU 856 gathering the UL buffered data for the TIDs reported in the BSR 846.
the non-AP MLD A 130 is therefore scheduled (more generally explicitly triggered) by frame 855 and can then perform the UL EML frame exchange by providing a response, here an EHT TB PPDU 857 gathering the UL buffered data for the TIDs reported in the BSR 847.

In other words, the BSRP trigger frame 845 is an initial frame triggering a frame exchange sequence over the first EML link, and the method, at the non-AP station comprises:
obtaining a scheduled UL resource within the frame exchange sequence; and
transmitting, within the scheduled UL resource, data having an UL TID that is mapped on the first EML link according to the UL TID-To-Link mapping as reported in the BSR frame.

Then, the AP MLD 110 through the affiliated AP 111 transmits a Block Acknowledgement frame 858 to knowledge the reception of EHT TB PPDUs 856 and 857.

Upon detecting the end of the frame exchanges, e.g. after block acknowledgment 858 (steps 650,745), non-AP MLD A 120 and non-AP MLD B 130 initiate the EML switch back 271 to the EML listening operation mode (step 655): the receiving EML co-affiliated STAs A1 121 and B1 131 switch back from the Enable frame exchange state 251, 253 to the Listening operation state 241, 243; the other EML co-affiliated STAs A2 122 and B2 132 switch back from the Disable frame exchange state 252, 254 to the Listening operation state 242, 244.

The EML switch back 271 corresponds either to the EMLSR Transition Delay or to the EMLMR delay as previously described.

FIG. 9 schematically illustrates a second possible operation handled in the flowcharts of FIGS. 6 and 7 using an exemplary sequence of frame exchange between the EML-capable AP MLD and EML-capable non-AP MLDs.

In this FIG. 9, the initial Control frame or Initial frame is a BSRP Trigger frame and the Initial Control frame response or Initial frame response is a BSR frame in a context of a MU UL OFDMA transmission.

The same references as FIGS. 2 and 8 correspond to the same frame/state or the like.

Again, the AP MLD 110 includes the two affiliated AP 111 and 112, the non-AP MLD 120 includes the two affiliated STA 121 and 122 and the non-AP MLD 130 includes two affiliated STA 131 and 132.

In this FIG. 9, it is assumed that the two affiliated STA 121 and 122 of non-AP MLD 120 and the two affiliated STA 131 and 132 of non-AP MLD 130 are able to send a BSR frame while being in the Listening operation state.

In the embodiment of this FIG. 9, unless clearly indicated, the negotiated TID-To-Link mapping between, firstly, AP MLD 110 and non-AP MLD 120 and between, secondly, AP MLD 110 and non-AP MLD 130 considered is the one described previously with reference to the FIG. 8.

In the FIG. 9, both non-AP MLDs 120 and 130 are EML active (i.e. either EMLSR active or EMLMR active) with the EML links (i.e. either EMLSR links or EMLMR links) corresponding to EML co-affiliated STAs 121 and 122 for non-AP MLD 120 and the EML links (i.e. either EMLSR links or EMLMR links) corresponding to EML co-affiliated STAs 131 and 132 for non-AP MLD 130. The non-AP MLDs 120 and 130 have activated the EML mode and indicated the EML links by sending an EML OM Notification frame to the AP MLD 110 (steps 610,710).

In this FIG. 9, it is considered that AP MLD 110, non-AP MLD 120 and non-AP MLD 130 operate under the “new EML operations” as defined above (steps 640-645, 750-756). This means that the MLDs have set both the Link Indication for UL EML Frame Exchange Support subfield to 1 during the ML setup (steps 600,700), and the Link Indication for UL EML Frame Exchange Mode subfield to 1 when activating the EML mode (step 610) or when Initiating the UL EML frame exchange (step 750).

At the beginning of the sequence, both non-AP MLDs 120 and 130 are in the EML listening operation state, meaning that the EML co-affiliated STAs 121 and 122 of non-AP MLD 120 are both in the listening operation state 241 and 242, as well the EML co-affiliated STAs 131 and 132 of non-AP MLD 130 are both in the listening operation state 243 and 244.

When the AP MLD 110 desires to initiate a frame exchange sequence with non-AP MLDs A 120 and B 130 to know their BSRs, it transmits through its affiliated AP AP1 111 a BSRP Trigger frame 945 (step 750) as Initial Control frame or Initial frame which is received by the EML co-affiliated STA A1 121 of the non-AP MLD 120 and the EML co-affiliated STA B1 131 of the non-AP MLD 130. The BSRP Trigger frame 945 schedules both non-AP MLD A 120 and non-AP MLD B 130.

In both non-AP MLD 120 and 130, the reception of the BSRP Trigger frame 945 initiates the EML switch 270 (step 640), corresponding either to the EMLSR active switch delay or to the EMLMR active switch delay as described previously. Operating under the new EML operations, both non-AP MLD 120 and 130 initiates the switch of their respective EML co-affiliated STA A1 121,122 and STA B1 131,132 based on the content of their respective BSR frames 946, 947 under preparation before transmission in response to the BSRP Trigger frame 945:
The BSR 946 under preparation by the non-AP MLD 120 indicating an amount of buffered uplink data for TIDs 0,3 mapped to the Link AP1, the non-AP MLD 120 initiates the switch of its receiving EML co-affiliated STA A1 121 from the listening operation state to the enabled frame exchange state on Link AP1. In parallel (synchronously), non-AP MLD 120 initiates the switch of its other EML co-affiliated STA A2 122 from the listening operation state to the disabled frame exchange state on the other link.
The BSR 947 under preparation by the non-AP MLD 130 indicating an amount of buffered uplink data for TIDs 4,5 mapped to the Link AP2, the non-AP MLD 130 initiates the switch of the its other EML co-affiliated STA B2 132 from the listening operation state to the enabled frame exchange state on Link AP2. In other words, the selected EML link (Link AP2) is a second EML link of the set of EML links different from the first EML link (Link AP1) over which is received the BSRP trigger frame and transmitted the BSR frame and the non-AP switches a first STA (STA B2) affiliated with the non-AP MLD and corresponding to the selected EML link (Link AP2) from a listening operation state to an enabled frame exchange state. In parallel (synchronously), non-AP MLD 130 initiates the switch of its receiving EML co-affiliated STA B1 131 from the listening operation state to the disabled frame exchange state on the other link.

Considering now another TID-To-Mapping, for example the Default TID-To-Link mapping or a negotiated TID-To-Link mapping with TID-To-Link Mapping Negotiation Supported subfield value=2, the BSR 946 and 947 under preparation can indicate the link (i.e. preferred link) to be used for EML frame exchange as follows:
The BSR 946 under preparation by the non-AP MLD 120 is in the format of a ML-BSR as described previously with reference to the FIG. 4a or 4b. This ML-BSR indicates an amount of buffered uplink data for TIDs 0,3 mapped to both Link AP1 and Link AP2 and it indicates the Link AP1. Then, the non-AP MLD 120 initiates the switch of its receiving EML co-affiliated STA A1 121 from the listening operation state to the enabled frame exchange state on Link AP1. In parallel (synchronously), non-AP MLD 120 initiates the switch of its other EML co-affiliated STA A2 122 from the listening operation state to the disabled frame exchange state on the other link.
The BSR 947 under preparation by the non-AP MLD 130 is in the format of a ML-BSR as described previously with reference to the FIG. 4a or 4b. This ML-BSR indicates an amount of buffered uplink data for TIDs 4,5 mapped to both Link AP1 and Link AP2 and it indicates the Link AP2. Then, the non-AP MLD 130 initiates the switch of its other EML co-affiliated STA B2 132 from the listening operation state to the enabled frame exchange state on Link AP2. In parallel (synchronously), non-AP MLD 130 initiates the switch of its receiving EML co-affiliated STA B1 131 from the listening operation state to the disabled frame exchange state on the other link.

Under this new EML operation, the link to be used for the EML frame exchange for a given non-AP MLD is based on the content of the BSR frame:
The link to be used for frame exchange may be indicated implicitly by the TIDs reported in the BSR and by the knowledge of the uplink TID-To-Link mapping. This implicit indication may be especially relevant under a negotiated TID-To-Link mapping with TID-To-Link Mapping Negotiation Supported subfield value=1.
The link to be used for frame exchange may be indicated explicitly by the Link ID indicated in the BSR, being a ML-BSR. This explicit indication may be especially relevant under a Default TID-To-Mapping or under a negotiated TID-To-Link mapping with TID-To-Link Mapping Negotiation Supported subfield value=2.

Once the preparation of the BSRs 946, 947 is completed, in response to the BSRP TF 945, receiving EML co-affiliated STA A1 121 of scheduled non-AP MLD A 120 transmits the BSR 946 (step 641) indicating the amount of buffered uplink data of the scheduled non-AP MLD A 120 and receiving EML co-affiliated STA B1 131 of scheduled non-AP MLD B 130 transmits a BSR 947 (step 641) indicating the amount of buffered uplink data of the scheduled non-AP MLD B 130.

Regarding the transmitted BSR frames 946 and 947, the AP MLD 110 and both non-AP MLDs 120 and 130 have applied the following rules specified by a particular embodiment of the present invention:

Rule 6: (non-AP MLD) After receiving a BSRP TF initiating an UL EML frame exchange and transmitting a BSR frame as a response to the BSRP TF, a non-AP MLD shall be able to transmit or receive frames on the EML link indicated, either implicitly or explicitly, in the BSR frame and shall not transmit or receive on the other EML link(s) until the end of the frame exchanges.

Rule 7: (AP MLD) After sending a BSRP TF initiating an UL EML frame exchange with at least one non-AP MLD and receiving a BSR frame as a response to the BSRP TF, an AP MLD shall be able to trigger an uplink frame exchange with the non-AP MLD on the EML link indicated, either implicitly or explicitly, in the BSR frame.

Rule 8: (MLD, i.e. non-AP MLD and AP MLD) In the case of an implicit EML link indication in a BSR, an MLD identifies the EML link to be used for frame exchange by the TID(s) reported in the BSR and the knowledge of the TID-To-Link mapping. In other words, the selected EML link is implicit to the TID(s) reported in the BSR frame, given the UL TID-To-Link mapping. In a particular embodiment, the reported TID or TIDs are mapped on a second EML link of the set of EML links and not on the first EML link.

With rule 8, the following applies:
The TIDs reported in the BSR frame should be mapped, preferably, to a same EML link:
   (No ambiguity, several TIDs reported) Under a negotiated TID-To-Link mapping with TID-To-Link Mapping Negotiation Supported subfield value=1, if the reported TIDs are mapped to the same EML link, the EML link to be used for frame exchange is this same EML link (i.e. being the receiving EML link or another link).
Otherwise, the following applies:
   (Ambiguity, due to all reported TIDs mapped to all EML links) Under a default TID-To-Mapping or under a negotiated TID-To-Link mapping with TID-To-Link Mapping Negotiation Supported subfield value=2, the EML link to be used for frame exchange is the receiving EML link (i.e. in which the BSRP TF was received).
   (Ambiguity, due to at least two reported TIDs mapped to at least two different EML links) Under a negotiated TID-To-Link mapping with TID-To-Link Mapping Negotiation Supported subfield value=1, if at least two reported TIDs are mapped to at least two different EML links, the EML link to be used for frame exchange is the receiving EML link (i.e. in which the BSRP TF was received).

Rule 9: (MLD) In the case of an explicit EML link indication in a BSR, an MLD identifies the EML link to be used for frame exchange by the Link ID indicated in the BSR (ML-BSR). In other words, the selected EML link is explicitly indicated in the BSR frame by a link identifier (Link ID).

With reference to the FIG. 3 described previously, as example, the BSRs 946 and 947 may use the 802.11ax BSR format 460:
For the BSR 946, the ACI Bitmap subfield 461 set to the value “0100” to indicate buffer data for AC1, the Delta TID subfield 462 is set to the value “01” to indicate buffered data for 2 TIDs and the Queue Size All subfield 466 is set to a value corresponding to the total amount of buffered data for these 2 TIDs, i.e. TIDs 0,3 being mapped to Link AP1.
   For the BSR 947, the ACI Bitmap subfield 461 set to the value “0010” to indicate buffer data for AC2, the Delta TID subfield 462 is set to the value “01” to indicate buffered data for 2 TIDs and the Queue Size All subfield 466 is set to a value corresponding to the total amount of buffered data for these 2 TIDs, i.e. TIDs 4,5 being mapped to Link AP2.

In this case, using the 802.11ax BSR format, the AP MLD 110 and non-AP MLD 120 identify the EML link AP1 to be used for frame exchange using the TIDs reported in the BSR 946 and the knowledge of the uplink TID-To-Link mapping described previously in reference to the FIG. 8. Similarly, using the 802.11ax BSR format, the AP MLD 110 and non-AP MLD 130 identify the EML link AP2 to be used for frame exchange using the TIDs reported in the BSR 947 and the knowledge of the uplink TID-To-Link mapping described previously in reference to the FIG. 8.

After the EML switch delay 270, both scheduled non-AP MLD 120 and non-AP MLD 130 have completed their switch from the EML listening operation mode to EML frame exchange mode (step 642), meaning the receiving EML co-affiliated STA A1 121 and the other EML co-affiliated STA B2 132 have switched respectively from the listening operation state 241, 244 to the enabled frame exchange state 251, 953, respectively on Link AP1 and Link AP2 (steps 643, 644), while the receiving EML co-affiliated STA B1 131 and the other EML co-affiliated STA A2 122 have switched respectively from the listening operation state 243, 242 to the disabled frame exchange state 954, 253, respectively on Link AP1 and Link AP2 (steps 643, 644),

Frame 955 can then be exchanged within the initiated frame exchange sequence (step 645, 743-745), i.e. over Link AP1 (Link #1) with affiliated AP AP1 111. Various types of frames 955 can be used, e.g. a downlink HE MU PPDU or a Basic TF frame to trigger MU UL OFDMA communication.

Similarly, Frame 955′ can then be exchanged within the initiated frame exchange sequence (step 645, 754-755), i.e. over Link AP1 (Other Link) with affiliated AP AP2 112. Various types of frames 955′ can be used, e.g. a downlink HE MU PPDU or a Basic TF frame to trigger MU UL OFDMA communication.

The AP MLD 110 through the affiliated AP AP1 111 transmits a Basic TF 955 containing RUs allocation information indicating that resource units are assigned for scheduled non-AP MLD A 120:
the non-AP MLD A 120 is therefore scheduled (more generally explicitly triggered) by frame 955 and can then perform the UL EML frame exchange by providing a response, here an EHT TB PPDU 956 gathering the UL buffered data for the TIDs reported in the BSR 946.

Then, the AP MLD 110 through the affiliated AP AP1 111 transmits a Block Acknowledgement frame 958 to knowledge the reception of EHT TB PPDUs 956.

Upon detecting the end of the frame exchanges, e.g. after block acknowledgment 958 (steps 650,745), non-AP MLD A 120 initiates the EML switch back 271 to the EML listening operation state (step 655): the receiving EML co-affiliated STAs A1 121 switches back from the Enable frame exchange state 251 to the Listening operation state 241; the other EML co-affiliated STAs A2 122 switches back from the Disable frame exchange state 252 to the Listening operation state 242.

The EML switch back 271 corresponds either to the EMLSR Transition Delay or to the EMLMR delay as previously described.

In parallel, the AP MLD 110 through the affiliated AP AP2 112 transmits a Basic TF 955′ containing RUs allocation information indicating that resource units are assigned for scheduled non-AP MLD A 130:
the non-AP MLD A 130 is therefore scheduled (more generally explicitly triggered) by frame 955′ and can then perform the UL EML frame exchange by providing a response, here an EHT TB PPDU 956′ gathering the UL buffered data for the TIDs reported in the BSR 947.

Variant “MU-RTS/CTS”: Here, in a variant, before the transmission of a Basic TF 955′ the AP MLD 110 through the affiliated AP AP2 112 transmits a MU-RTS TF 960 and the non-AP MLD 130 through the affiliated non-AP MLD 132 replies with a CTS frame 961. This relates to so-called MU-RTS/CTS procedure introduced in IEEE Std 802.11ax™-2021 and corresponds to an extension of the RTS/CTS handshake mechanism used to reserve the channel in multi-user UL/DL scenarios. It allows an AP to reserve a TXOP for multi-user transmission by sending a multi-user request control frame, noted MU-RTS frame, to request reservation of one or more 20 MHz communication channels. In response of the MU-RTS frame, the solicited/intended STA sends a CTS frame. In this variant, the MU-RTS frame 960 may constitute an Initial Control frame or Initial frame on Link AP2, thus permitting some other EML active non-AP MLDs to be triggered in the upcoming UL EML frame exchange on Link AP2. This MU-RTS/CTS procedure may also, using basic frames which can be decoded by legacy stations, permit to NAV-protects (i.e. neighboring stations set their Network Allocation Vector (NAV) preventing them to initiate any transmission opportunity) the Link AP2 before the upcoming UL EML frame exchange.

This variant “MU-RTS/CTS” (in which the initial frame is a MU-RTS, frame) can be generalized as follows:
at the non-AP MLD: over the second EML link (Link AP2), which is different from the first EML link (Link AP1) over which is received the BSRP trigger frame (945), receiving an initial frame (960) triggering a frame exchange sequence on the second link, before receiving a Basic Trigger frame (955′) scheduling an UL resource to the non-AP MLD within the frame exchange sequence;
at the AP MLD: over the second EML link (Link AP2), which is different from the first EML link (Link AP1) over which is transmitted the BSRP trigger frame (945), transmitting an initial frame (960) triggering a frame exchange sequence on the second link, before transmitting a Basic Trigger frame (955′) scheduling an UL resource to the non-AP MLD within the frame exchange sequence.

In a particular embodiment (of the variant “MU-RTS/CTS” or of its generalization), the initial frame contains an invitation to other non-AP MLDs to be triggered in an incoming UL EML frame exchange on the second EML link.

Then (returning to FIG. 9), the AP MLD 110 through the affiliated AP AP2 112 transmits a Block Acknowledgement frame 958′ to knowledge the reception of EHT TB PPDUs 956′.

Upon detecting the end of the frame exchanges, e.g. after block acknowledgment 958′ (steps 650,756), non-AP MLD B 130 initiates the EML switch back 271 to the EML listening operation state (step 655): the receiving EML co-affiliated STAs B1 131 switches back from the Disable frame exchange state 954 to the Listening operation state 243; the other EML co-affiliated STAs B2 132 switches back from the Enable frame exchange state 953 to the Listening operation state 244.

The EML switch back 271 corresponds either to the EMLSR Transition Delay or to the EMLMR delay as previously described.

FIG. 10 schematically illustrates a variant of the second possible operation illustrated in reference to the FIG. 9 considering the case of EML-active non-AP MLDs having a specific constraint for the transmission of a BSR frame.

The same references as FIGS. 2 and 9 correspond to the same frame/state or the like.

Again, the AP MLD 110 includes the two affiliated AP 111 and 112, the non-AP MLD 120 includes the two affiliated STA 121 and 122 and the non-AP MLD 130 includes two affiliated STA 131 and 132.

In this FIG. 10, contrary to the FIGS. 8 and 9 described previously, it is assumed that the two affiliated STA 121 and 122 of non-AP MLD 120 and the two affiliated STA 131 and 132 of non-AP MLD 130 are not able to send a BSR frame while being in the Listening operation state; it is assumed that they need to have completed their EML switch 1070 and to be in the Enabled frame exchange state to be able to send a BSR frame.

This variant may reflect some constraints related to the hardware implementation of non-AP MLD 120 and 130.

In this FIG. 10, the concept of the new EML operation mode of embodiments of the present invention is the same as described previously in reference to the FIG. 9. Therefore, it will not be described in detail again here, rather only the implications related to the new assumption for BSR transmission will be described.

When the AP MLD 110 desires to initiate a frame exchange sequence with non-AP MLDs A 120 and B 130 to know their BSRs, it transmits through its affiliated AP AP1 111 a BSRP Trigger frame 945 as Initial Control frame or Initial frame which is received by the EML co-affiliated STA A1 121 of the non-AP MLD 120 and the EML co-affiliated STA B1 131 of the non-AP MLD 130. The BSRP Trigger frame 945 schedules both non-AP MLD A 120 and non-AP MLD B 130.

In both non-AP MLD 120 and 130, the reception of the BSRP Trigger frame 945 initiates the EML switch 1070, corresponding either to the EMLSR Padding delay or to the EMLMR Delay as described previously. Operating under the new EML operations but being constraint to send a BSR frame while being in the Enable frame exchange state, both non-AP MLD 120 and 130 initiate the switch of their respective receiving EML co-affiliated STA A1 121 and STA B1 131 from their Listening operation states 241, 243 to their Enabled frame exchange states 251, 1053 on the link in which the BSRP TF 945 was received, i.e. Link AP1, while they initiate the switch of their respective other EML co-affiliated STA A2 122 and STA B2 132 from their Listening operation states 242, 244 to their Disabled frame exchange states 252, 1054 on the other link, i.e. Link AP2.

After the EML switch delay 1070, both scheduled non-AP MLD 120 and non-AP MLD 130 have completed their switch. Then, in response to the BSRP TF 945, receiving EML co-affiliated STA A1 121 of scheduled non-AP MLD A 120 transmits the BSR 946 indicating the amount of buffered uplink data of the scheduled non-AP MLD A 120 and receiving EML co-affiliated STA B1 131 of scheduled non-AP MLD B 130 transmits a BSR 947 indicating the amount of buffered uplink data of the scheduled non-AP MLD B 130.

Then, both non-AP MLD 120 and 130 may initiate or not a subsequent switch of their respective EML co-affiliated STA A1 121, A2 122 and STA B1 131, B2 132 based on the content of their respective BSR frames 946, 947 transmitted on the link in which the BSRP TF was received, i.e. Link AP1:
The BSR 946 transmitted by the non-AP MLD 120 indicating an amount of buffered uplink data for TIDs 0,3 mapped to the Link AP1, the non-AP MLD 120 remains in the same state and doesn't need to initiate a subsequent switch of its EML co-affiliated STA A1 121 and STA A2 122.
The BSR 947 transmitted by the non-AP MLD 130 indicating an amount of buffered uplink data for TIDs 4,5 mapped to the Link AP2, the non-AP MLD 130 need to initiate a subsequent switch of its EML co-affiliated STA B1 131 and B2 132. It then initiates the subsequent EML switch 1070′ in order to switch its other EML co-affiliated STA B2 132 from the Disabled operation state 1054 to the Enabled frame exchange state 953 on Link AP2. In parallel (synchronously), non-AP MLD 130 initiates the subsequent switch of its receiving EML co-affiliated STA B1 131 from the Enable frame exchange state 1053 to the Disabled frame exchange state 954 on the Link AP1.

The remaining part of the sequence of frame exchange is the same as previously described in reference to the FIG. 9, thus it will not be described again here.

It should be pointed out that this FIG. 10, which is a variant of the FIG. 9, is not fully handled by the flowcharts of FIGS. 6 and 7. However, the man with skills in the art will be able to adapt these flowcharts, if needed, for a full handling of this variant.

FIG. 11 schematically illustrates an EMLSR capable architecture for an MLD. This Figure takes the example of two affiliated non-AP STAs sharing the hardware resources of their non-AP MLD when the EMLSR mode is activated. The EMLSR capable architecture for an MLD presented in this Figure is for illustrative purpose only and other alternative architectures may be contemplated.

The architecture comprises two radio stacks, a Light radio stack and a Full radio stack.

The full radio stack comprises a full 802.11be MAC module 800a (exchanging data with higher layers), a full 802.11be PHY module 805a connected with the full MAC module, a full radio-frequency chain 815a connected with the full PHY module and the antennas 820a connected with the full RF chain through an EMLSR switch 810.

The light radio stack comprises a light 802.11be MAC module 800b (exchanging data with higher layers), a light 802.11be PHY module 805b connected with the light MAC module, a light radio-frequency chain 815b connected with the light PHY module and the antennas 820b connected with the light RF chain through the EMLSR switch 810.

The EMLSR switch 810 is shared by the two radio stacks and configured to switch, when the EMLSR mode is activated, the EMLSR co-affiliated STAs from/to Listening operation state to/from Enable or Disable Frame Exchange states.

The radio chain 800a/805a/815a is a full radio resource allowing reception and transmission of any IEEE802.11 frames. In particular, it includes encoding and decoding modules to encode and decode any IEEE802.11 frames. On the other hand, the radio chain 800b/805b/815b is a reduced function (or “light”) radio resource which only allows reception and transmission of specific IEEE802.11 frames. In particular, it only includes encoding and decoding modules to encode and decode specific frames using a rate of 6 Mbps, 12 Mbps, or 24 Mbps.

The diagram on the bottom left illustrates the functioning of the MLD when the non-AP MLD is in the EMLSR listening operation mode: the common EMLSR switch 810 connects each radio chain 800a/805a/815a and 800b/805b/815b to antennas 820a and 820b, respectively. Hence, each radio stack can be used to simultaneously listen to a respective link. As shown in the Figure, two links are available. The full radio chain 800a/805a/815a and antennas 820a are configure to operate on the Link1, the light radio chain 800b/805b/815b and antennas 820b are configured to operate on the Link2.

The diagram on the bottom center illustrates the functioning of the MLD when the non-AP MLD switches in a first EMLSR frame exchange mode. The EMLSR co-affiliated STA corresponding to Link 1 is in the enabled frame exchange state, while the other EMLSR co-affiliated STA corresponding to Link 2 is in the disabled frame exchange state. In that case, the common EMLSR switch 810 connects the full radio chain 800a/805a/815a to both antennas 820a and 820b and the full radio chain 800a/805a/815a and antennas 820a/820b are configured to operate on the Link1. Here, as the full radio chain remains configured to operate on Link 1, the EMLSR switch duration from Listening operation state to Enable frame exchange state may be considered as short. Indeed, in this case, the switch only involves an antenna switch. In the meantime, the common EMLSR switch 810 disconnects the light radio chain 800b/805b/815b from the antennas 820b. In this configuration, the light radio chain 800b/805b/815b is not able to received or transmit any frame on Link 2. Then, only Link 1 is available.

The diagram on the bottom right illustrates the functioning of the MLD when the non-AP MLD switches in a second EMLSR frame exchange mode. The EMLSR co-affiliated STA corresponding to Link 2 is in the enabled frame exchange state, while the other EMLSR co-affiliated STA corresponding to Link 1 is in the disabled frame exchange state. In that case, the common EMLSR switch 810 connects the full radio chain 800a/805a/815a to both antennas 820a and 820b and the full radio chain 800a/805a/815a and antennas 820a/820b are configured to operate on the Link2. Here, as the full radio chain switches to operate on Link 2, the EMLSR switch duration from Listening operation state to Enable frame exchange state may be considered as long. Indeed, in this case, the switch involves both an antenna switch and the full radio chain configuration switch. In the meantime, the common EMLSR switch 810 disconnects the light radio chain 800b/805b/815b from the antennas 820b. In this configuration, the light radio chain 800b/805b/815b is not able to received or transmit any frame on Link 1. Then, only Link 2 is available.

The functioning of the common EMLSR switch 810 clearly shows that the change of states for two EMLSR co-affiliated STAs in the same MLD is necessarily simultaneous because the antenna resources are either connected to one of the STAs or to the other, but never remains available for both STAs at the same time.

FIG. 12 schematically illustrates an EMLMR capable architecture for an MLD. This Figure takes the example of two affiliated non-AP STAs sharing their antenna resources when the EMLMR mode is activated.

The architecture comprises two radio stacks, one for each non-AP STA.

A radio stack comprises a full 802.11be MAC module 900a or 900b (exchanging data with higher layers), a full 802.11be PHY module 905a or 905b connected with the MAC module, a radio-frequency chain 915a or 915b connected with the PHY module, an EMLMR switch 910 shared by the two radio stacks and configured to perform the aggregation of the antenna resources when the EMLMR mode is activated, and an antenna array 920a or 920b.

The diagram on the bottom left illustrates the functioning when the non-AP MLD is listening to an initial frame: the common EMLMR switch 910 connects each antenna array to its RF chain. Hence, each radio stack is complete and can serve a respective link using for example a 2×2 MIMO antenna configuration. As shown in the Figure, two links are available.

The diagram on the bottom center illustrates the functioning of the MLD when the non-AP MLD switches in a first EMLMR frame exchange mode. The EMLMR co-affiliated STA corresponding to Link 2 is in the enabled frame exchange state, while the other EMLMR co-affiliated STA corresponding to Link 1 is in the disabled frame exchange state. The common EMLMR switch 910 aggregates the antenna resource to Link 2. To do so, it connects the antenna array 920a of the second radio stack to the RF chain 915b of the first radio stack. Hence, the first radio stack can operate in a 4×4 MIMO antenna configuration to improve the throughput over Link 2. On the other hand, Link 1 can no longer be used as its antenna array 920a is no longer available for the second radio stack.

The diagram on the bottom right illustrates the functioning of the MLD when the non-AP MLD switches in a second EMLMR frame exchange mode. The EMLMR co-affiliated STA corresponding to Link 1 is in the enabled frame exchange state, while the other EMLMR co-affiliated STA corresponding to Link 2 is in the disabled frame exchange state. The common EMLMR switch 910 aggregates the antenna resource to Link 1. To do so, it connects the antenna array 920b of the first radio stack to the RF chain 915a of the second radio stack. Hence, the second radio stack can operate in a 4×4 MIMO antenna configuration to improve the throughput over Link 1. On the other hand, Link 2 can no longer be used as its antenna array 920b is no longer available for the first radio stack.

The functioning of the common EMLMR switch 910 clearly shows that the change of states for two EMLMR co-affiliated STAs in the same MLD is necessarily simultaneous because the antenna resources are either connected to one of the STAs or to the other, but never remain available for both STAs at the same time.

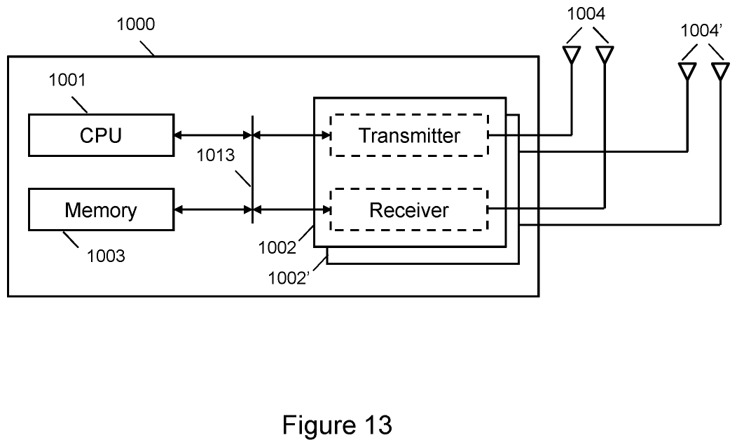

FIG. 13 schematically illustrates a communication device 1000, typically any of the MLDs discussed above, of a wireless network, configured to implement at least one embodiment of the present invention. The communication device 1000 may preferably be a device such as a micro-computer, a workstation or a light portable device. The communication device 1000 comprises a communication bus 1013 to which there are preferably connected:

a central processing unit 1001, such as a processor, denoted CPU;

a memory 1003 for storing an executable code of methods or steps of the methods according to embodiments of the invention as well as the registers adapted to record variables and parameters necessary for implementing the methods; and at least two communication interfaces 1002 and 1002′ connected to the wireless communication network, for example a communication network according to one of the IEEE 802.11 family of standards, via transmitting and receiving antennas 1004 and 1004′, respectively.

Preferably the communication bus 1013 provides communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk or on a removable digital medium such as for example a disk. According to an optional variant, the executable code of the programs can be received by means of the communication network, via the interface 1002 or 1002′, in order to be stored in the memory of the communication device 1000 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising, at a non-access point, non-AP, multi-link device, MLD operating on multi-links with an Uplink, UL, Traffic IDentifier(TID)-To-Link mapping:
activating an Enhanced Multi-Link, EML, mode, wherein activating the EML mode includes selecting a set of EML links in which links the EML mode is applied, as a function of the UL TID-To-Link mapping, and transmitting to an AP MLD a notification specifying the selected set of EML links; and/or
while the non-AP MLD operates in an EML mode with a set of EML links, transmitting, in response to a Buffer Status Report Poll, BSRP, trigger frame received from the AP MLD over a first EML link of the set of EML links, a BSR frame reporting buffered traffic as a function of the UL TID-To-Link mapping, to the AP MLD, over the first EML link.

2. The method of claim 1, wherein selecting the set of EML links as a function of the UL TID-To-Link mapping comprises fulfilling a constraint that at least one EML link of the set of EML links shall have at least one UL TID mapped according to the UL TID-To-Link mapping.

3. The method of claim 2, wherein the constraint that at least one EML link of the set of EML links shall have at least one UL TID mapped applies if the UL TID-To-Link mapping is a negotiated UL TID-To-Link mapping with a TID-To-Link Mapping Negotiation Supported subfield value equal to 1.

4. The method of claim 1, wherein selecting the set of EML links as a function of the UL TID-To-Link mapping comprises fulfilling a constraint that the set of EML links shall not be disjoint from another set of links on each of which all UL TIDs are mapped according to the UL TID-To-Link mapping.

5. The method of claim 4, wherein the constraint that the EML links of the set of EML links shall not be disjoint from said other set of links applies if the UL TID-To-Link mapping is a negotiated UL TID-To-Link mapping with a TID-To-Link Mapping Negotiation Supported subfield value equal to 2.

6. The method of claim 1, wherein the BSR frame reports buffered traffic, if any, of at least one UL TID that is mapped on the first EML link according to the UL TID-To-Link mapping.

7. The method of claim 1, wherein the BSR frame reports buffered traffic, if any, only of UL TID(s) that is (are) mapped on the first EML link according to the UL TID-To-Link mapping.

8. The method of claim 7, wherein the constraint that the BSR frame reports buffered traffic, if any, of at least one UL TID that is mapped, or only UL TID(s) that is (are) mapped, on the first EML link according to the UL TID-To-Link mapping applies if the UL TID-To-Link mapping is a negotiated UL TID-To-Link mapping with a TID-To-Link Mapping Negotiation Supported subfield value equal to 1.

9. The method of claim 1, wherein the BSRP trigger frame is an initial frame triggering a frame exchange sequence over the first EML link, and the method, at the non-AP station, further comprises:
obtaining a scheduled UL resource within the frame exchange sequence; and
transmitting, within the scheduled UL resource, data having an UL TID that is mapped on the first EML link according to the UL TID-To-Link mapping as reported in the BSR frame.

10. The method of claim 1, further comprising, at the non-AP MLD,
transmitting to the AP MLD a signaling information indicating which of the two following submodes of the EML mode is to be used:
a first submode of the EML mode including said transmission of the BSR frame reporting buffered traffic as a function of the UL TID-To-Link mapping; and
a second submode of the EML mode, in which, in response to a BSRP trigger frame received from the AP MLD over the first EML link, the non-AP MLD transmits to the AP MLD, over the first EML link, a BSR frame indicating a selected EML link among the set of EML links which is to be used for a frame.

11-17. (canceled)

18. A communication method in a wireless network, comprising, at an access point multi-link device, AP MLD, configured to carry out frame exchange operations, with at least one non-AP MLD, operating on multi-links with an Uplink, UL, Traffic IDentifier(TID)-To-Link mapping:
transmitting to the non-AP MLD, over a first enabled link, a Buffer Status Report Poll, BSRP, trigger frame, TF;
receiving from the non-AP MLD, over the first enabled link, a BSR frame reporting buffered traffic; and
transmitting to the non-AP MLD, over the first enabled link, a Basic TF scheduling an UL resource to the non-AP MLD and containing a constraint, based on the UL TID-To-Link mapping, on the data to be transmitted within the scheduled UL resource.

19. The method of claim 18, wherein the constraint on the data to be transmitted within the scheduled UL resource is indicated by a value of an Access Category, AC, corresponding to UL TIDs that are mapped on the first enabled link according to the UL TID-To-Link mapping.

20. The method of claim 19, wherein the value is indicated in a preferred AC subfield of a Trigger Dependent User Info field of a User Info field corresponding to the scheduled UL resource within the Basic TF.

21. The method of claim 19, wherein the constraint on the data to be transmitted by the non-AP MLD applies if the UL TID-To-Link mapping is a negotiated UL TID-To-Link mapping with a TID-To-Link Mapping Negotiation Supported subfield value equal to 1.

22. The method of claim 18, wherein at least one UL TID is mapped, according to the UL TID-To-Link mapping, on the first enabled link on which is transmitted the BSRP TF.

23. A communication method in a wireless network, comprising, at an access point multi-link device, AP MLD, configured to carry out frame exchange operations, with at least one non-AP MLD, operating on multi-links with an Uplink, UL, Traffic IDentifier(TID)-To-Link mapping:
transmitting to the non-AP MLD, over a first enabled link on which at least one UL TID is mapped according to the UL TID-To-Link mapping, a Buffer Status Report Poll, BSRP, trigger frame, TF.

24. The method of claim 23, further comprising, at the AP MLD, transmitting to the non-AP MLD a signaling information indicating which of the two following submodes of the EML mode is to be used:
a first submode of the EML mode including said transmission of the Basic TF scheduling the UL resource to the non-AP MLD and containing the constraint, based on the UL TID-To-Link mapping, on the data to be transmitted within the scheduled UL resource; and
a second submode of the EML mode, in which the AP MLD retrieves from the BSR frame an indication of a selected EML link to be used for a frame exchange and transmits to the non-AP MLD, over the selected EML link, a Basic TF to trigger an uplink frame exchange with the non-AP MLD on the selected EML link.

25-37. (canceled)

38. A wireless communication device comprising at least one microprocessor configured for carrying out the method of claim 40.

39. A non-transitory computer-readable medium storing a program which, when executed by a microprocessor or computer system in a wireless device, causes the wireless device to perform the method of claim 48.

40. A communication method in a wireless network, comprising, at an access point, AP, affiliated with an AP multi-link device, MLD, and operating on a link for exchanging frames with a non-AP station affiliated with a non-AP MLD,
transmitting, over the link, a Basic trigger frame, TF, scheduling an uplink, UL, resource to the affiliated non-AP station and containing a preferred AC subfield in a Trigger Dependent User Info field of a User Info field corresponding to the scheduled UL resource within the Basic TF;
wherein the preferred AC subfield is set to a value for an AC for which at least one corresponding TID is mapped in UL to the link for the non-AP MLD by a Traffic IDentifier(TID)-To-Link mapping.

41. The method of claim 40, wherein the TID-To-Link mapping is negotiated between the AP MLD and the non-AP MLD.

42. The method of claim 40, further comprising:
transmitting, over the link, a Buffer Status Report Poll, BSRP, trigger frame, TF; and
receiving from the affiliated non-AP station, over the link, a BSR frame reporting buffered traffic.

43. An access point, AP, affiliated with an AP multi-link device, MLD,
adapted to operate on a link of a wireless network for exchanging frames with a non-AP station affiliated with a non-AP MLD, the affiliated AP comprising:
a transmitter configured to transmit, over the link, a Basic trigger frame, TF, scheduling an uplink, UL, resource to the affiliated non-AP station and containing a preferred AC subfield in a Trigger Dependent User Info field of a User Info field corresponding to the scheduled UL resource within the Basic TF;
wherein the preferred AC subfield is set to a value for an AC for which at least one corresponding TID is mapped in UL to the link for the non-AP MLD by a Traffic IDentifier(TID)-To-Link mapping.
